(19) United States
(12) Patent Application Publication
(10) Pub. No.: US 2026/0015991 A1
(43) Pub. Date: Jan. 15, 2026

(54) SYSTEMS, METHODS, AND DEVICES FOR BLADE PITCH ADJUSTMENT

(71) Applicant: KW WIND ENERGY LTD., Surrey (CA)

(72) Inventors: Wesley Allen NOON, Saskatoon (CA); Kelly LAST, Vancouver (CA)

(21) Appl. No.: 19/267,243

(22) Filed: Jul. 11, 2025

Related U.S. Application Data
(60) Provisional application No. 63/670,663, filed on Jul. 12, 2024.

(51) Int. Cl. F03D 1/06

(52) U.S. Cl. CPC F03D 1/0664; F05D 2260/70

(57) ABSTRACT

Described herein are systems, devices, and methods for a blade pitch adjustment device, comprising: a hub connectible to a wind turbine, the hub engageable with at least one blade device each at a blade connection portion, each blade connection portion permitting adjustment of the pitch of the blade device. Each blade device can be rotatably engaged with the hub where the adjustment of the pitch of each blade device is by simultaneous rotation of each blade device.

### FIELD

The present disclosure relates to the field of wind turbines and, in particular, to attachments for wind turbines.

### BACKGROUND

Many commercial and other buildings exhaust air in order to help maintain a healthy and clean air environment inside the building. Commercial type buildings such as schools, office towers, and large buildings have air exhaust units that run anywhere from 50% to 100% of the time. These exhaust units create fresh air exchange for office buildings to keep clean fresh air circulating through the building. All make up air (MUA) units pull fresh air into the building and the air exhaust units (EU) remove air (exhaust) from the buildings. Ashrae Standards state that four air changes per hour should be made for a standard office building and warehouse. This means that the air in a building is 100% cycled four times an hour or 96 times in a 24 hour period. This means that fresh (outside) air is being cycled into the building for a 100% change every 15 minutes on average, meaning that the air within the building has to be removed at a rate to keep up with this 100% air cycle each hour. These EUs run 365 days/year. In the winter, they exhaust air that the heating units bring in to heat the building and, in the summer, they exhaust the air that the HVAC units bring in to cool the building. All buildings “breath” day and night to maintain the buildings clean air and also for moisture control. This air is simply exhausted into the environment and any wind energy carried by the exhausted air is lost.

These air exhausts or other units that generate wind can provide a static and continuous flow of air. This flow of air is unlike typical natural wind environments. In natural wind environments, the flow of air is not static and constant but can change quickly, stop unpredictably, or decrease in flow. Existing wind turbines are adapted to capture this type of natural and changing wind and accordingly are designed to capture as much air flow as possible to actuate the turbine to convert the wind energy to electrical energy. Accordingly, these existing wind turbines do not need to allow for adjustment of the pitch of the blades of the wind turbine as the wind it is designed to capture fluctuates quickly and the blade pitch cannot be optimized for a single flow rate as the wind flow is not at a constant rate but instead fluctuates. Furthermore, these wind turbines are large and are often positioned in open fields so as to maximize the capture of natural wind.

Existing wind turbines are typically too large to be used to capture wind from building exhausts and also cannot be adjusted to optimize the capture of static wind from building exhausts or other mechanical units, nor be optimized to prevent the wind turbine from going into overcurrent or undercurrent status. For example, existing wind turbines have a fixed blade pitch which, even if they were sized to be positioned near an exhaust, depending on the particular pitch that the blades happen to be at, may either capture too much wind energy from the exhaust and go into overcurrent status where the blades rotate too quickly and energy generation from the wind turbine is impaired or impeded, or capture too little wind energy from the exhaust and go into undercurrent status where the blades rotate too slowly and little to no energy is generated by the wind turbine. Overcurrent status is undesirable as it will shut the wind turbine down or burn it out, while undercurrent status does not allow the wind turbine to generate as much energy as desired.

Accordingly, a continuing need exists in the field of wind turbines to address these limitations.

This background information is provided for the purpose of making known information believed by the applicant to be of possible relevance to the present disclosure, No admission is necessarily intended, nor should be construed, that any of the preceding information constitutes prior art against the present disclosure.

### SUMMARY

In accordance with an aspect, there is provided a blade pitch adjustment device, including: a hub connectible to a wind turbine, the hub engageable with at least one blade device each at a blade connection portion, each blade connection portion permitting adjustment of the pitch of the blade device.

In some embodiments, each blade device is rotatably engaged with the hub and the adjustment of the pitch of each blade device is by simultaneous rotation of each blade device.

In some embodiments, the blade pitch adjustment device further includes a first gear rotatably engageable with at least one second gear, each at least one second gear rotatably engageable with one of the blade devices, wherein the adjustment of the pitch of each blade device is by rotation of the first gear.

In some embodiments, each blade connection portion includes a toothed connection.

In some embodiments, the hub has angled teeth engageable with angled teeth of each blade device at each blade connection portion.

In some embodiments, at least one of the angled teeth of the hub or the angled teeth of each blade device are present along the entire perimeter of the hub or blade device.

In some embodiments, the blade pitch adjustment device further includes a blade shaft at a hub connection portion of each blade device and extending from inside the blade device to outside the blade device, the blade shaft engageable with the hub.

In some embodiments, for each blade device, the blade shaft extends outside the blade device at a rod portion, the rod portion extendible through the hub.

In some embodiments, the hub further includes a ring gear, the ring gear positioned over a hub base, a perimeter of the hub configured to receive a pinion shaft of at least one of the at least one blade, each pinion shaft rotatable with rotation of the ring gear to adjust a pitch of each blade.

In some embodiments, each pinion shaft is received by the hub at equally spaced intervals along the perimeter of the hub.

In some embodiments, the blade pitch adjustment device further includes a locking mechanism compressible and releasable to lock and unlock the ring gear.

In accordance with an aspect, a method for adjusting a pitch of at least one blade of a wind turbine is provided, the method including: detaching the at least one blade from the wind turbine; rotating the at least one blade to a specified pitch; and attaching the at least one blade to the wind turbine at the specified pitch.

In some embodiments, the method further includes increasing a number of toothed engagement points between the at least one blade and the wind turbine when the at least one blade is attached to the wind turbine.

In some embodiments, the wind turbine comprises a wind turbine and a hub, the detaching being from the bub, the attaching being to the hub.

In some embodiments, the detaching includes loosening a connection of a blade shaft extending through the hub, the attaching including tightening the connection of the blade shaft extending through the hub.

In accordance with an aspect, there is provided a method for adjusting a pitch of each blade of a wind turbine, the method including: rotationally connecting each blade to the wind turbine about an axis relative to which blade pitch is measured and rotationally connecting each blade directly or indirectly to at least one gear.

In some embodiments, the at least one gear is a same single toothed device.

In some embodiments, the method further includes simultaneously adjusting the pitch of each blade by rotating the at least one gear.

In some embodiments, the at least one gear includes only one first gear rotatably engaged with two or more subsequent gears each rotatably engaged with one of the blades.

In some embodiments, the method further includes locking the gear to impede rotation of each blade.

### BRIEF DESCRIPTION OF THE DRAWINGS

These and other features will become more apparent in the following detailed description in which reference is made to the appended drawings.

FIG. 1A is a schematic view of a wind turbine having a blade pitch adjustment device and installed at an exhaust, in accordance with some embodiments;

FIG. 1B is a schematic view of a wind turbine having a blade pitch adjustment device and installed at an exhaust, in accordance with some embodiments;

FIG. 2A is a schematic view of a wind turbine, in accordance with some embodiments;

FIG. 2B is a schematic view of a wind turbine, in accordance with some embodiments;

FIG. 3 is a side view of a blade pitch adjustment device, in accordance with some embodiments;

FIG. 4A is a top view of a hub of a blade pitch adjustment device, in accordance with some embodiments;

FIG. 4B is a partial cross-sectional side view of a hub of a blade pitch adjustment device, in accordance with some embodiments;

FIG. 5 is a partial cross-sectional side view of a hub of a blade pitch adjustment device, in accordance with some embodiments;

FIG. 6 is a top view of a hub of a blade pitch adjustment device, in accordance with some embodiments;

FIG. 7 is a side view of a blade including a blade device, in accordance with some embodiments;

FIG. 8 is a side view of a blade shaft of a blade, in accordance with some embodiments;

FIG. 9 is a front view of a blade pitch adjustment device with blade devices installed, in accordance with some embodiments;

FIG. 10 is a side view of a blade, in accordance with some embodiments;

FIG. 11 is a side view of a hub connection portion of a blade device, in accordance with some embodiments;

FIG. 12 is a side view of a connection portion of a blade shaft, in accordance with some embodiments;

FIG. 13 is a side view of a blade device, in accordance with some embodiments;

FIG. 14 is a side view of a blade device, in accordance with some embodiments;

FIG. 15 is a side view of a blade device, in accordance with some embodiments;

FIG. 16 is a side view of a blade device, in accordance with some embodiments;

FIG. 17 is a side view of a blade device, in accordance with some embodiments;

FIG. 18 is a side view of a blade device, in accordance with some embodiments;

FIG. 19 is a side view of a blade device, in accordance with some embodiments;

FIG. 20 is a side view of a blade device, in accordance with some embodiments;

FIG. 21 is a side view of a blade pitch adjustment device, in accordance with some embodiments;

FIG. 22 is a schematic view of an enhanced blade pitch adjustment device, in accordance with some embodiments;

FIG. 23 is a schematic view of a hub of an enhanced blade pitch adjustment device, in accordance with some embodiments;

FIG. 24 is a schematic view of an enhanced blade pitch adjustment device, in accordance with some embodiments;

FIG. 25A is a perspective view of a blades attached to a blade pitch adjustment device, according to some embodiments;

FIG. 25B is an exploded view of a blade pitch adjustment device, according to some embodiments;

FIG. 26A is a top view of a hub, according to some embodiments;

FIG. 26B is a side view of a hub, according to some embodiments;

FIG. 26C is a top perspective view of a hub, according to some embodiments,

FIG. 26D is a side view of a hub, according to some embodiments;

FIG. 27A is a side view of a hub bearing cap, according to some embodiments;

FIG. 27B is a top perspective view of a hub bearing cap, according to some embodiments;

FIG. 27C is a bottom view of a hub bearing cap, according to some embodiments;

FIG. 27D is a sectional view of a hub bearing cap along the plane denoted by A-A in FIG. 27C, according to some embodiments;

FIG. 28A is a bottom view of a lock plate, according to some embodiments;

FIG. 28B is a side view of a lock plate, according to some embodiments;

FIG. 28C is a bottom view of a lock plate, according to some embodiments;

FIG. 28D is a sectional view of a lock plate along the plane defined by A-A in FIG. 28B, according to some embodiments;

FIG. 28E is a perspective view of a lock plate, according to some embodiments;

FIG. 29A is top view of a ring gear 5, according to some embodiments;

FIG. 29B is a side view of a ring gear 5, according to some embodiments;

FIG. 29C is a top perspective view of a ring gear 5, according to some embodiments;

FIG. 30A is a top view of a bevel pinion, according to some embodiments;

FIG. 30B is a sectional view of bevel pinion along the plane defined by A-A in FIG. 30B, according to some embodiments;

FIG. 30C is a top sectional view of a bevel pinion, according to some embodiments,

FIG. 31A is a top view of a shaft cap, according to some embodiments;

FIG. 31B is a sectional view of a shaft cap along the plane defined by A-A in FIG. 31B, according to some embodiments;

FIG. 31C is a top perspective view of a shaft cap, according to some embodiments;

FIG. 32A is a side view of an adjusting device, according to some embodiments,

FIG. 32B is a sectional view of an adjusting device along the plane defined by A-A in FIG. 32A, according to some embodiments;

FIG. 32C is a bottom view of an adjusting device, according to some embodiments;

FIG. 32D is a top perspective view of an adjusting device, according to some embodiments;

FIG. 33A is a top view of a stepped key, according to some embodiments;

FIG. 33B is a side view of a stepped key, according to some embodiments,

FIG. 33C is a perspective view of a stepped key, according to some embodiments;

FIG. 34A is a side view of a nose cone, according to some embodiments;

FIG. 34B is a sectional view of a nose cone along the plane defined by A-A in FIG. 34A, according to some embodiments;

FIG. 34C is a perspective view of a nose cone, according to some embodiments;

FIG. 35A is a view of a shaft spacer ring, according to some embodiments;

FIG. 35B is a sectional view of a shaft spacer ring along the plane defined by A-A in FIG. 35A, according to some embodiments;

FIG. 35C is a top view of a shaft spacer ring, according to some embodiments;

FIG. 35D is a perspective view of a shaft spacer ring, according to some embodiments;

FIG. 36A is a side view of a blade, according to some embodiments;

FIG. 36B is a sectional view of a blade along a plane defined by A-A in FIG. 36A, according to some embodiments;

FIG. 37 is a blade pitch adjustment device with blades attached, according to some embodiments;

FIG. 38 is a blade pitch adjustment device with blades attached, according to some embodiments;

FIG. 39 is a sectional view of a blade pitch adjustment device with blades attached, according to some embodiments; and

FIG. 40 is a perspective view of a blade pitch adjustment device, according to some embodiments.

### DETAILED DESCRIPTION OF EMBODIMENTS

In accordance with some embodiments, there is provided a blade pitch adjustment device attachable to a wind turbine that is sized to fit on building rooftops or otherwise positioned near building exhausts or other wind-generating units to enable the capture and conversion of wind generated by these exhausts or other units to electrical energy or other energy usable or storable in a power grid. Uniquely, this blade pitch adjustment device enables the adjustment of the pitch of the blades of the wind turbine so that the wind turbine can be optimized to maximize turbine rotation without going into overcurrent status, as well as prevent undercurrent status where little to no wind is captured by the wind turbine. Accordingly, the energy generated from the wind turbine can be optimized for the wind speed (e.g., generated by an exhaust) that it is designed to capture. For example, too little blade pitch catches too much air and makes the blades spin too fast putting the unit into overcurrent, while too much blade pitch does not catch enough air and the blades will not spin fast enough putting the unit into an undercurrent state where it may not produce the optimal or maximum current possible.

In some embodiments, the blade pitch adjustment device provides for manual adjustment. In such embodiments, the blade pitch adjustment device includes teeth on a blade device that engage with complementary teeth on a hub, where the blade device can be rotated to adjust the pitch of the blade and (re)engaged with the teeth of the hub at a different position. The blade pitch adjustment device can accommodate multiple blade devices attached to a single hub.

In some alternative embodiments, the blade pitch adjustment device is configured for automatic adjustment. In such embodiments, a ring gear can be included with the hub and engageable with pinion shafts of each blade device, such that rotation of the ring gear rotates the pitch of each and every blade device engaged with the hub, which can allow for automatic adjustment of the pitches of all of the blades of the wind turbine simultaneously. In some embodiments, in place of pinion shafts, a gear (e.g., bevel pinion; or toothed connection) is rotatably engageable with the ring gear and with a blade device, such that rotation of the ring gear rotates the gear which rotates the blade device which is engaged in an orientation that such rotation adjusts the pitch of the blade device. In some embodiments, there is a separate gear engaged with each blade device, with all such gears engaged with a single ring gear. In some embodiments, the ring gear can be a different type of gear. In some embodiments, a first device is rotatably engageable with all blade devices (or with a component connected thereto directly or indirectly) such that actuation, movement, or rotation (as the case may be in different embodiments) of the first device actuates, moves, or rotates (as the case may be in different embodiments) one or more blade devices in a manner that adjusts the pitch of the blade devices. The pitch of each blade device can be adjusted in this manner simultaneously and to the same degree, according to some embodiments.

In other embodiments, the pitch of each blade device is adjusted in sequence and to the same or different degree. For example, multiple and/or different numbers of gears or other components can be engaged between the first device (e.g., ring gear) and each different blade device, such that the single movement, rotation, or actuation of the device (e.g., ring gear) triggers movement or rotation of each blade device to a defined degree according to the respective interconnected components between the device (e.g., ring gear) and each respective blade device.

According to certain embodiments, the blade pitch can be optimized for the particular purpose and/or wind source. For example, using data on the typical wind speed (e.g., m/s) from particular building exhausts or mechanical units, the blade pitch adjustment device, before or during installation at a site, can be configured with a pitch for each blade that is close to or optimized for the type of exhaust or mechanical unit whose wind it is configured to capture.

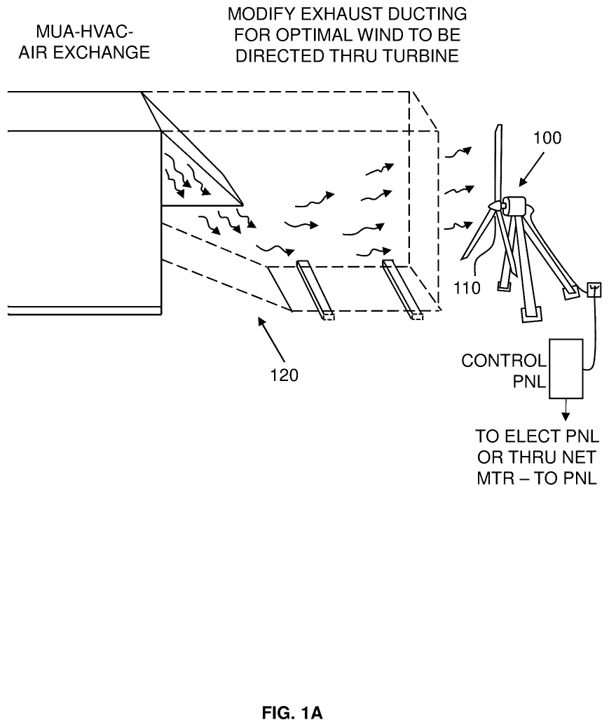

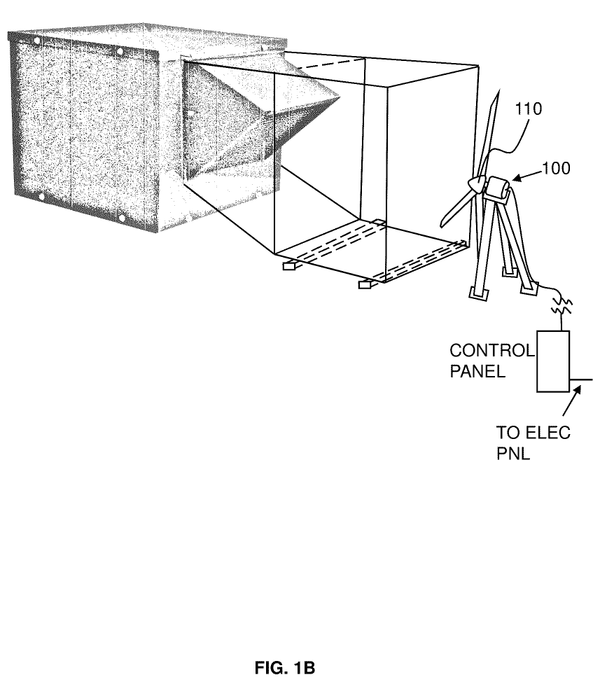

FIG. 1A shows an example wind turbine 100 having an example blade pitch adjustment device 110 and installed at an air source 120, in accordance with some embodiments. Air source 120 can be an exhaust, such as a make up air (MUA)-HVAC-air exchange, a commercial rooftop exhaust, or a wind energy source, for example. Air source 120 can include an air outlet and have exhaust ducting modified for optimal wind to be directed through the wind turbine 100 such as shown in FIG. 1A.

FIG. 1B shows an example blade pitch adjustment device 110 of a wind turbine 100 installed at an exhaust, in accordance with some embodiments. Wind turbine 100 can be placed at a location selected based on the nature of the air flow from the exhaust (e.g., speed, direction, current, number). Wind turbine 100 can be placed in proximity to one or more exhausts to receive air flow from one or more of the exhausts simultaneously.

In some embodiments, a control panel is connected to the wind turbine 100 and is used to configure an energy destination for energy generated by wind turbine 100. For example, wind turbine 100 can direct energy to storage, to an energy grid, for use by the same or other building(s) it is installed at, or for another use. The control panel can be used to configure an electrical panel (e.g., to configure a destination of the energy produced) and/or to a net meter to allow charge back to utilities. For example, the energy generated can be used to offset a cost of energy used by an entity or owner or used at the building or location that the wind turbine 100 is installed.

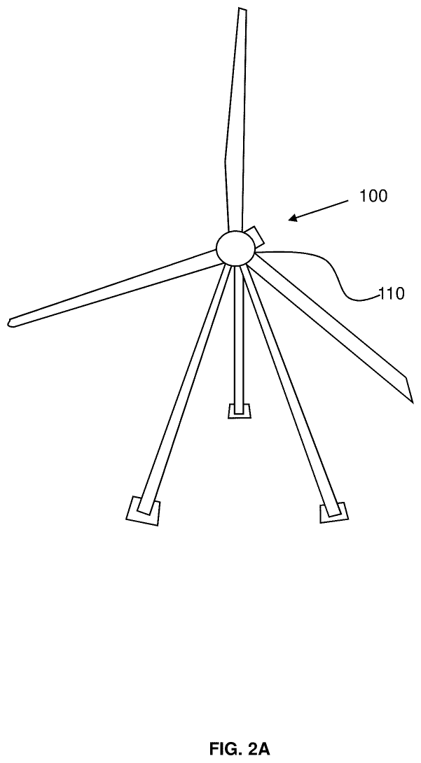

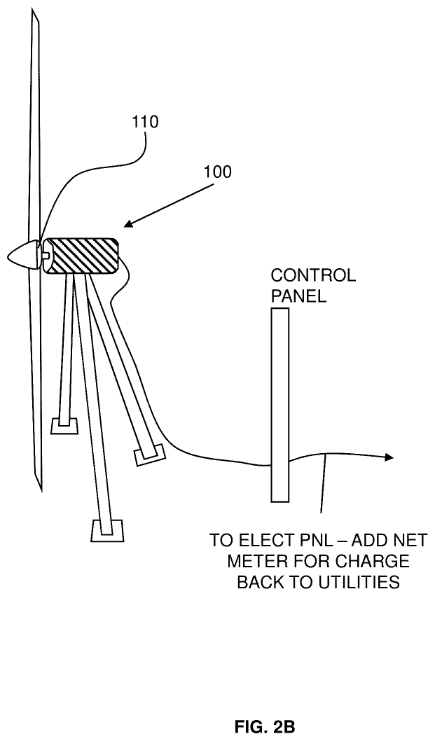

FIG. 2A shows a front view of an example wind turbine 100 with an example a blade pitch adjustment device 110, where wind turbine 100 has three blades connected to a hub, the hub connected to the wind turbine, in accordance with some embodiments. Other numbers of blades can be used in different embodiments. For example, the number of blades can be two, three, four, five, six, or any greater number of blades depending on the size of assembly. The number of blades can be selected to be optimized on the use, amount of energy to be generated, amount of wind, wind source, and/or wind speed, for example.

FIG. 2B shows a side view of an example wind turbine 100 with an example blade pitch adjustment device 110, in accordance with some embodiments. Different wind turbine designs can be used in various embodiments. The number of legs of the wind turbine and general structure as shown in the drawings are examples. Other numbers of legs and designs can be used.

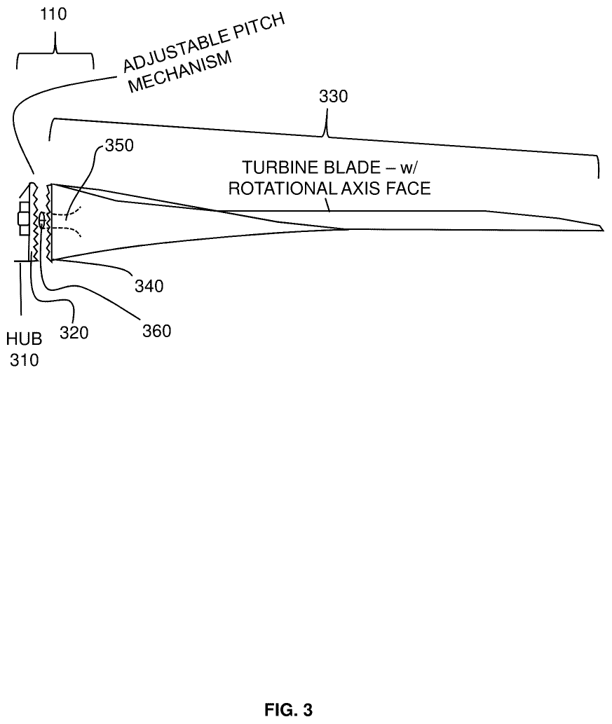

FIG. 3 shows a side view of an example blade pitch adjustment device 110, in accordance with some embodiments. In some embodiments, a blade pitch adjustment device 110 includes a blade device 330; and a hub 310 connectible to a wind turbine 100, the hub 310 engageable with the blade device 330 at a blade connection portion 320, the blade connection portion 320 permitting adjustment of the pitch of the blade device 330. Blade device 330 can include a blade or wing of a wind turbine 100 or be a separate device attachable to a blade or wing, according to various embodiments. The blade or wing can be a turbine blade with a rotational axis face such as shown in FIG. 3, such as configured to improve, optimize, or facilitate capture of wind energy. For example, the blade can be shaped or curved or configured with a sloped face. The blade can be convex on its back and concave on its front, for example.

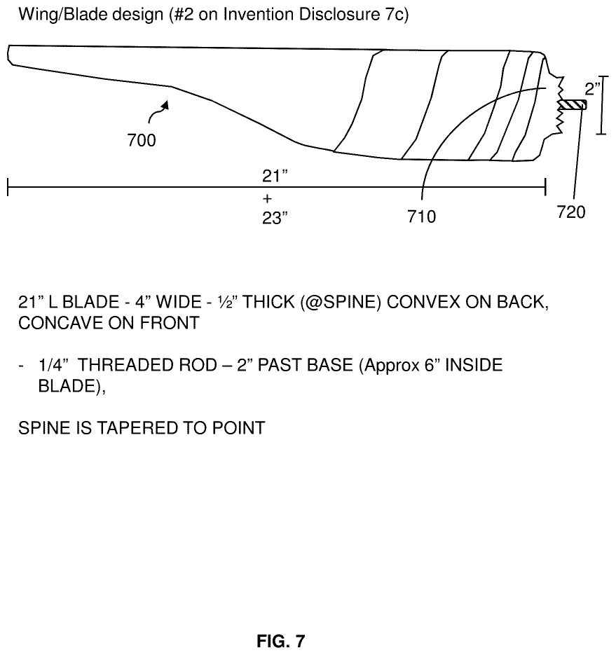

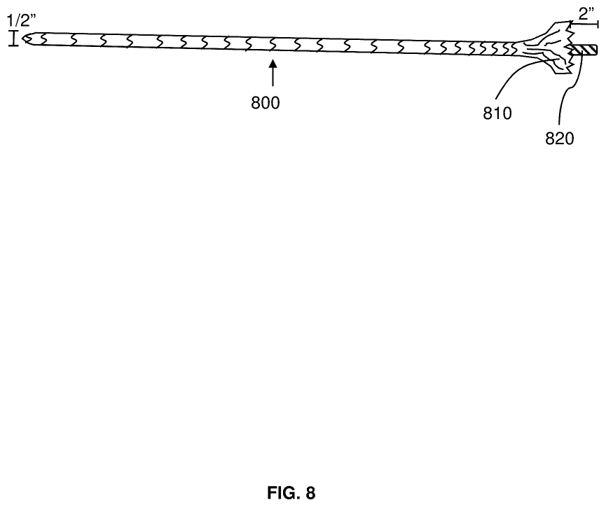

Hub 310 includes a blade connection portion 320. Blade device 330 includes hub connection portion 340 engageable with hub 310 at blade connection portion 320. In some embodiments, blade device 330 also includes blade shaft 350 insertable in blade device 330 at hub connection portion 340. Blade shaft 350 has a connector 360 that extends outside blade device 330 and is insertable inside hub 310 at blade connection portion 320. Connector 360 is configured to connect and secure blade device 330 to hub 310. FIG. 7 shows another example connector 720, and FIG. 8 shows another example connector 820. Connector 360, 720, 820 can be a rod, for example. Connector 360, 720, 820 is threaded for secure attachment with corresponding receiving portions in the hub, in some embodiments.

In some embodiments, the blade device connection portion 320 comprises a toothed connection. The teeth can be at various angles in different embodiments. For example, each tooth can be at a five degree angle. Other angles can be used in different embodiments. The size, angle, and spacing of the teeth can be configured based on how the blade pitch is to be adjusted, for example. In some embodiments, the angle could be as sharp as 1 degree up to 20 degrees. In some embodiments, each tooth is about ⅛″ to ¼″ deep. In some embodiments, such as for larger turbine applications, deeper teeth can be used so as to increase strength of connection.

In some embodiments, hub 310 has angled teeth engageable with angled teeth of the blade device 330 at the blade connection portion 320. Blade device 330 at hub connection portion 340 has angled teeth complementary to angled teeth of hub 310 at blade connection portion 320. When engaged, the teeth of hub 310 and blade device 330 facilitate a secure connection between hub 310 and blade device 330. The connection allows blade device 330 and hub 310 to rotate together when wind turbine 110 is in use, according to some embodiments.

The toothed connection between hub 310 and blade device 330 allow for incremental adjustments to the pitch of blade device 330 (or, specifically, to a blade portion included or attached to blade device 330 as understood to be the case throughout this disclosure when referring to a pitch of the blade device). In some embodiments, adjusting a pitch of blade device 330 proceeds in the following manner. The connection between hub 310 and blade device 330 is loosened (e.g., by loosening connector 360) to allow for some separation between blade connection portion 320 and hub connection portion 340. Blade device 330 can be rotated relative to hub 310 to adjust the pitch of blade device 330, and blade connection portion 320 and hub connection portion 340 can be brought back together to engage the respective teeth on each component to reform a toothed connection. The connection between hub 310 and blade device 330 can then be tightened (e.g., by tightening connector 360).

In some embodiments, at least one of the angled teeth of hub 310 or the angled teeth of blade device 330 are present along the entire perimeter of hub 310 or blade device 330. For example, in some embodiments, teeth are present and contiguous along the entire perimeter of blade connection portion 320 of hub and engageable with teeth present and contiguous along the entire perimeter of hub connection portion 340 of blade device 330. In some embodiments, fewer teeth are present along each perimeter and are spaced apart but engageable with complementary teeth to facilitate securing blade device 330 with hub 310.

In some embodiments, hub 310 is fixedly attached to wind turbine 100. For example, hub 310 can be bolted directly to wind turbine.

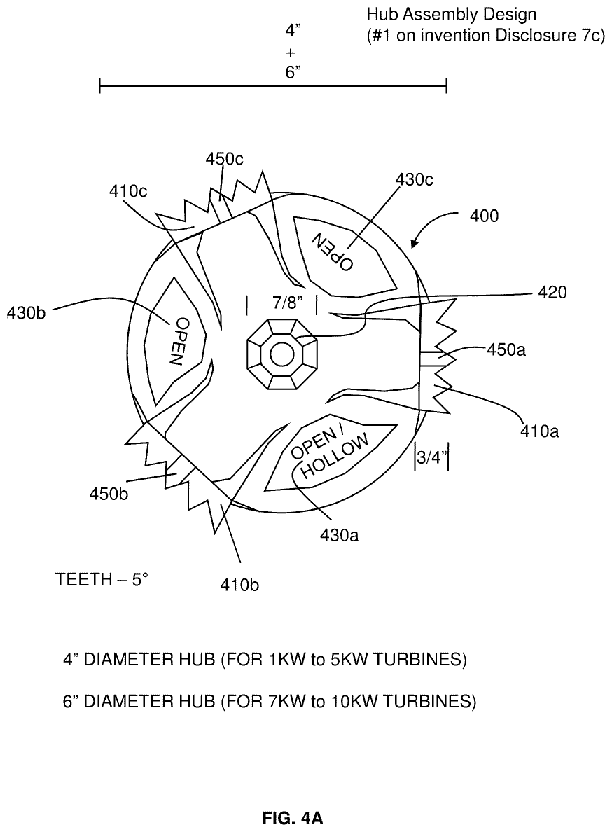

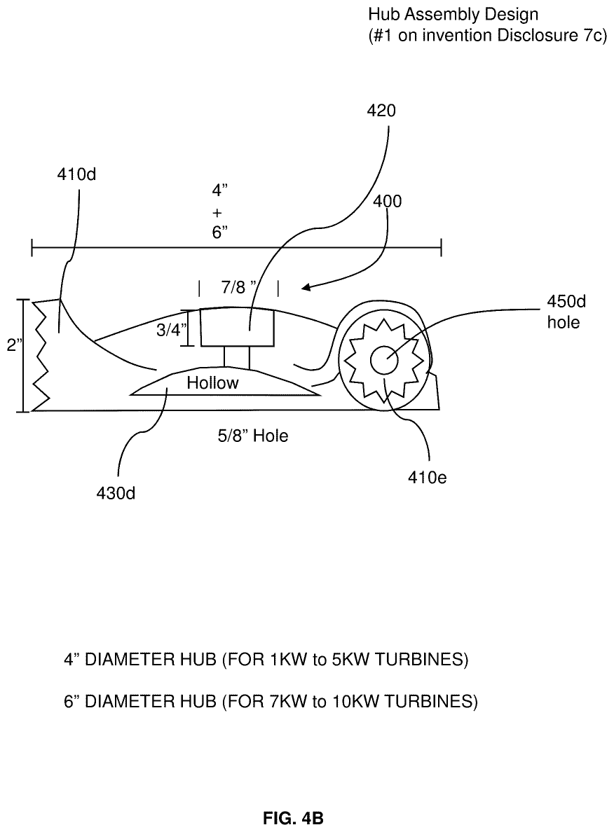

FIG. 4A is a top view of an example hub 400 of a blade pitch adjustment device 110, in accordance with some embodiments. In some embodiments, hub 400 includes one or more blade connection portions, such as 410a, 410b, and 410c, each blade connection portion 410 located along a perimeter of hub 400. Each blade connection portion 410 is evenly spaced along hub 400 in some embodiments. The number, size, and spacing of blade connection portion(s) 410 can be selected based on the number of blades, type of wind turbine, and nature of air flow that blade pitch adjustment device 110 is used with.

In some embodiments, each blade connection portion 410 includes a receiving portion such as 450a, 450b, and 450c. Receiving portion 450 can be a channel that extends a distance into hub 400 and is configured to receive a connector such as connector 360 of blade shaft 350. In some embodiments, hub 400 includes an open or hollow portion 430 positioned in a face of hub 400 between adjacent sections of hub 400 to which blade connection portions 410 are connected. Open portions 430a, 430b, and 430c are shown between hub portions having blade connection portions 450a/450b, 450b/450c, and 450c/450a, respectively, in the example shown. Hub 400 includes a turbine connection portion 420. Turbine connection portion 420 is located at the centre of a face of hub 400 in the embodiment shown in FIG. 4A.

The size and shape of hub 400 is configurable based on the turbine type, size, or use to which hub 400 is employed. For example, a four inch diameter hub can be used for 1 kW to 5 kW turbines, and a six inch diameter hub can be used for 7 kW to 10 kW turbines. The length or diameter of turbine connection portion 420 can be ⅞ inches, for example.

FIG. 4B shows a partial cross-sectional side view of a hub 400 of a blade pitch adjustment device 110, in accordance with some embodiments. In the example shown, the height or thickness of blade connection portion 410 is two inches at its highest point where it is engageable with a blade device 330; the length or diameter of turbine connection portion is ⅞ inches with a depth extending into the body of hub 400 being ¾ inches; and receiving portion 450 5/16 inches wide or in diameter (e.g., to receive a ¼ inch fastening rod from a blade). Receiving portion 450 can be a hole which has a length that is continuous through blade connection portion 410. Turbine connection portion 420 can be ⅝ inches in diameter with a length that goes through the full depth of hub 400 to a ⅞ inch opening that receives a connecting nut for fastening to a turbine. Other dimensions can be used in other embodiments. In FIG. 4B, a side view of blade connection portion 410d; an end view of blade connection portion 410e of hub 400; a cross section of turbine connection portion 420 are shown; and a cross section of open portion 430d is shown. Turbine connection portion 420 can be shaped and configured to receive, engage, and/or retain a corresponding portion of wind turbine 100. Each blade connection portion 410 includes a receiving portion 450 configured to receive a connector (e.g., connector 360, 720, or 820) of blade shaft 350. Receiving portion 450 can be a channel or hole, for example.

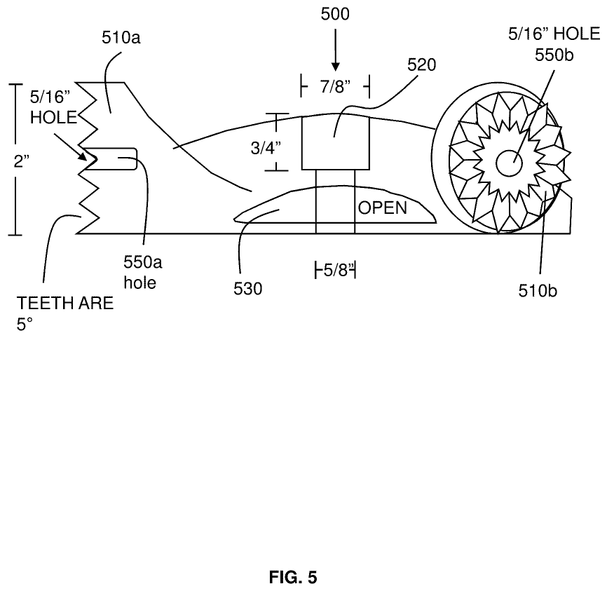

FIG. 5 shows a partial cross-sectional side view of an example hub 500 of a blade pitch adjustment device 110, in accordance with some embodiments. As shown, hub 500 includes blade connection portions 510, such as 510a and 510b, each having a receiving portion 550, specifically, 550a and 550b, respectively. In the embodiment shown, each receiving portion 550 is a hole configured to receive a rod or connector (e.g., connector 360, 720, 820) from a blade shaft, such as blade shaft 800. Each hole is 5/16 inches wide, and each blade connection portion 510 is two inches wide, measured along the same axis and at the widest portion, which, in the embodiment shown, is the portion of blade connection portion 510 where teeth are present. Hub 500 includes an open portion 530 in its body. Each open portion 530 can facilitate reducing the weight of hub 500, for example, by removing excess material without reducing the strength or functionality of hub 500. Hub 500 includes turbine connection portion 520 on its face near the centre of its body. Turbine connection portion 520 is configured to receive an engagement from a turbine, such as wind turbine 100, to form a secure engagement. For example, wind turbine 100 can be bolted to turbine connection portion 520. Turbine connection portion 520 can be ⅞ inches wide at its opening on the face of hub 500 and ¾ inches deep at this opening, with a deeper ⅝ inch wide channel extending through the body of hub 500. Other turbine connection portion 520 shapes and dimensions can be used to accommodate different turbine connections, in various embodiments. Blade connection portion 510 slopes upward from the centre of hub 500 to the end of blade connection portion 510 where teeth are present. Dimensions other than those described in this embodiment can be used in other embodiments.

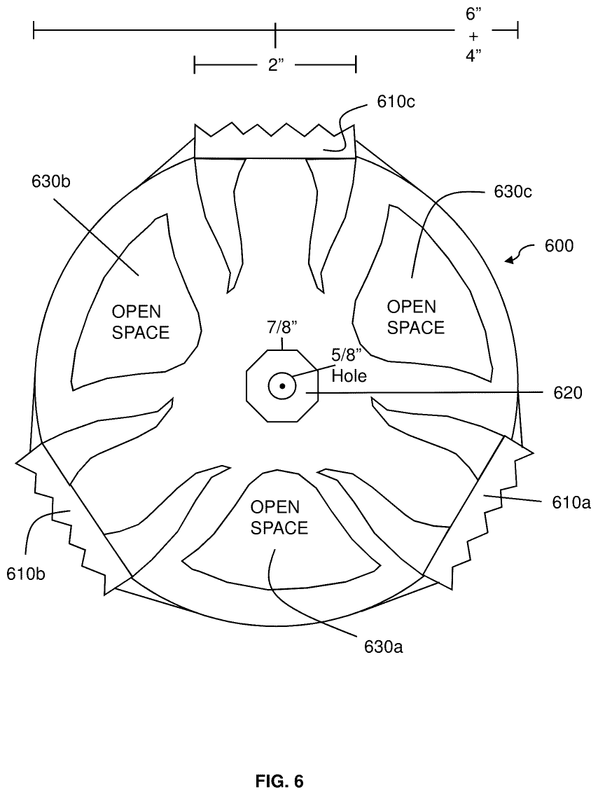

FIG. 6 shows a top view of a hub 600 of a blade pitch adjustment device 110, in accordance with some embodiments. Hub 600 includes blade connection portions 610a, 610b, and 610c, with open portions 630a, 630b, and 630c between 610a/610b, 610b/610c, and 610c/610a, respectively. Hub 600 includes a turbine connection portion 620 comprising a ⅝ inch diameter hole that extends through the body of hub 600 and is positioned within a recessed portion that measures about ⅞ inches at its widest dimension. This arrangement of turbine connection portion 620 can facilitate engagement with wind turbine 110 via a rod inserted through the hole secured with a bolt fitted at the recessed portion. Each toothed portion of blade connection portion 610 is two inches wide measured along the teeth, while the diameter of hub 600 is six inches or four inches. Dimensions other than those described in this embodiment can be used in other embodiments.

FIG. 7 shows a side view of an example blade including an example blade device 700, in accordance with some embodiments. In some embodiments, the length of blade device 700 is 21 inches or 33 inches, while the width of hub connection portion 710 (measured along a toothed portion) is two inches. In other embodiments, other dimensions can be used.

FIG. 8 shows a side view of an example blade shaft 800 of an example blade, in accordance with some embodiments. In some embodiments, blade device 700 includes a blade shaft 800 at a hub connection portion 710 of blade device 700 and extending from inside blade device 700 to outside blade device 700, blade shaft 800 engageable with hub 310. For example, in some embodiments, blade shaft 800 is insertable inside blade device 700 at a hub connection portion 710, such that an end of blade shaft 800 is aligned with an end of blade device 700 at hub connection portion 710. For a 21 inch long blade device 700 that is 4 inches wide and ½ inches thick at its spine, blade shaft 800 can be a ¼ inch threaded rod extending about six inches inside blade device 700 at hub connection portion. In some embodiments, blade shaft 800 includes a connector 820 that extends, in this example embodiment, two inches past the end of hub connection portion 710 of blade device 700. Connector 820 is insertable inside hub 310 in receiving portion 450 (or 550) at blade connection portion 320. In some embodiments, pitch adjustment of blade device 700 is performed by loosening the connection between blade shaft 800 and hub 310 (e.g., by loosening a connecting nut on blade shaft 800). In some embodiments, blade shaft 800 extends outside blade device 700 at a connector 820 (or 720), connector 820 (or 720) extendible through hub 310. Connector 820 (or 720) can be a rod, for example.

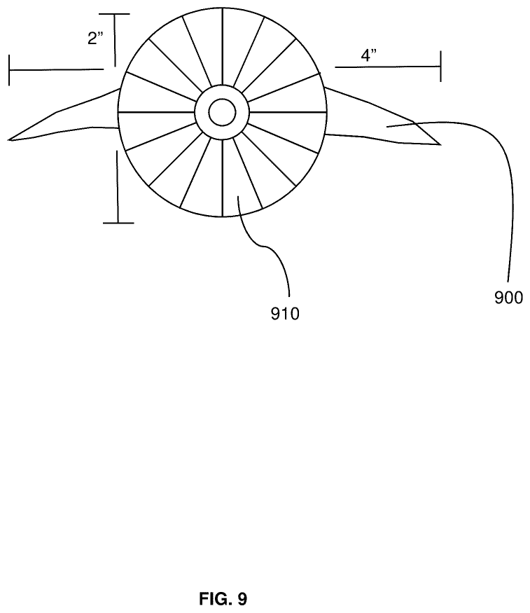

FIG. 9 is a front view of a blade pitch adjustment device 110 with blade devices 900 installed, in accordance with some embodiments. As shown, in some embodiments, blade device 900 is attached to hub 910 and extends four inches from hub 910, while the distance measured from the highest point of attachment of blade device 900 to the outer perimeter of hub 910 along the same axis is two inches. In some embodiments, other dimensions can be used.

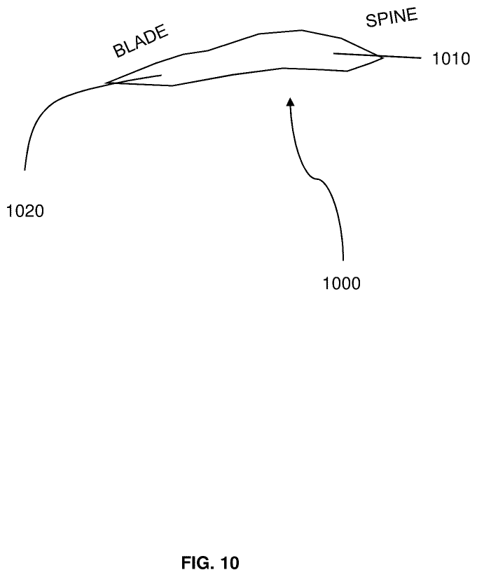

FIG. 10 shows a side view of an example blade device 1000, in accordance with some embodiments. In some embodiments, blade device 1000 includes a blade portion 1020 extending to one end and a spine portion 1010 extending to the other end. Spine portion 1010 is closer to a hub connection portion 340 than blade portion 1020.

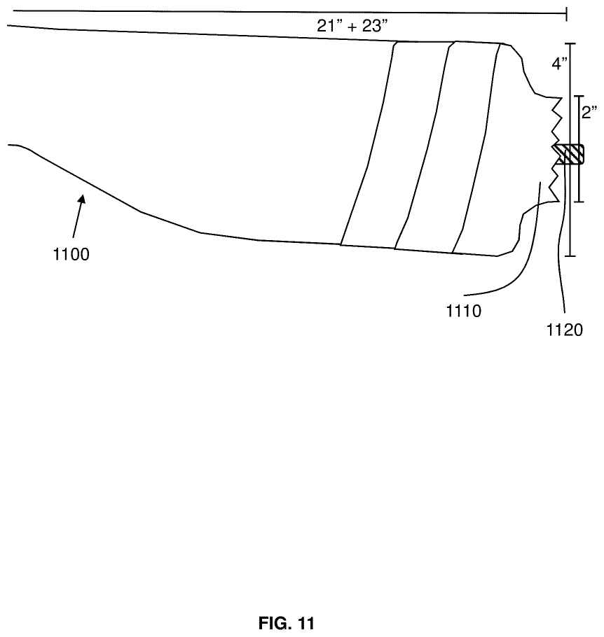

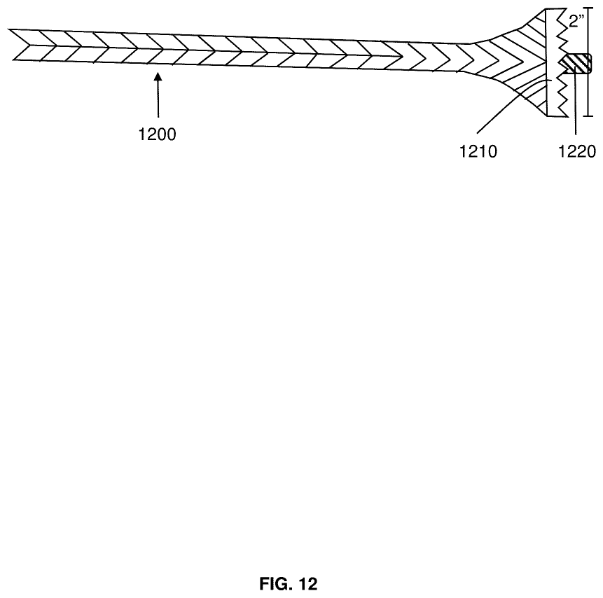

FIG. 11 shows a side view of a hub connection portion 1110 of a blade device 1100, in accordance with some embodiments. FIG. 12 shows a side view of a connection portion 1210 of a blade shaft 1200, in accordance with some embodiments. As shown, hub connection portion 1110 and connection portion 1210 of blade shaft 1200 are both toothed connections. When assembled, blade shaft 1200 is inserted inside blade device 1100 at hub connection portion 1110, such that the teeth of connection portion 1210 and hub connection portion 1110 are along the same axis and are configured for engagement with a blade connection portion, such as 510b shown in FIG. 5. Blade shaft 1200 includes a connector 1220 such as a rod that extends from this axis and is configured to be received at a receiving portion of a blade connection portion, such as at receiving portion 550b as shown in FIG. 5. In some embodiments, the length of blade device 1100 is 21 inches or 33 inches, while its width is four inches and the width of the toothed portion at hub connection portion 1110 is two inches, measured along the same axis. The width of the toothed portion of blade shaft 1200 at connection portion 1210 can also be two inches or smaller. In some embodiments, other dimensions can be used.

In some embodiments, there is provided a method for adjusting a pitch of at least one blade of a wind turbine 110, the method including detaching the at least one blade from the wind turbine 110; rotating the at least one blade to a specified pitch; and attaching the at least one blade to the wind turbine 110 at the specified pitch. The number of toothed engagement points between the at least one blade and the wind turbine when the at least one blade is attached to the wind turbine can be increased. This can provide a more fine-tuned ability to adjust the pitch of the blade. Blade is included in blade device 330, according to some embodiments.

In some embodiments, wind turbine 110 includes a wind turbine 110 and a hub 310, the detaching being from hub 310, the attaching being to the hub 310.

In some embodiments, the detaching is performed by loosening a connection of a blade shaft 800 (or 1200) extending through the hub 310, the attaching comprising tightening the connection of the blade shaft 800 (or 1200) extending through the hub 310.

In alternative embodiments, a blade pitch adjustment device includes pre-pitch blades that have no adjustment ability but are instead fixed to a hub. If the pitch is to be adjusted, the pre-pitch blades are replaced with replacement pre-pitch blades.

In another alternative embodiment, a blade pitch adjustment device includes a hub and blade system that can be adjusted just by turning a “knob” on the hub, which changes the pitch of all the blades at once. An example of this alternative embodiment will now be described.

In some embodiments, the bub includes a ring gear positioned over a hub base, a perimeter of the hub configured to receive a pinion shaft of each blade, where each pinion shaft rotates with the rotation of the ring gear to adjust a pitch of each blade connected to each pinion shaft. For example, the perimeter of the hub that receives the pinion shaft(s) is a bearing or sleeve and support in some embodiments. Each pinion shaft can be secured to the hub by retaining clips or other fastener.

In some embodiments, each pinion shaft is received by the hub at equally spaced intervals along the perimeter of the hub.

In some embodiments, the hub includes a locking mechanism that is compressible and releasable to lock and unlock the ring gear. For example, the locking mechanism can include arms extending in a spindle configuration (e.g., from the centre of the hub) to engage and be retained by holes. These holes can be configured in a circular formation between the centre of the hub and ring gear, for example. Upon compression of the locking mechanism, the arms can disengage with the holes and unlock the position of the ring gear and, accordingly, allow the pitch of each blade to be adjusted by rotating the ring gear. Upon release of the locking mechanism, the arms can engage with the holes and lock the position of the ring gear and, accordingly, prevent the pitch of each blade from being adjusted by rotation of the ring gear. In some embodiments, compression of the locking mechanism engages the arms with the holes, while release of the locking mechanism disengages the arms from the holes and unlocks the position of the ring gear. In some embodiments, a different locking mechanism is used to allow and prevent adjustment of the pitch of each blade. In some embodiments, the ring gear and/or the pattern of holes is circular. In some embodiments, the ring gear and/or the pattern of holes is not circular or not ring shaped, and references to rotation of the ring gear is to be interpreted as movement of the ring gear.

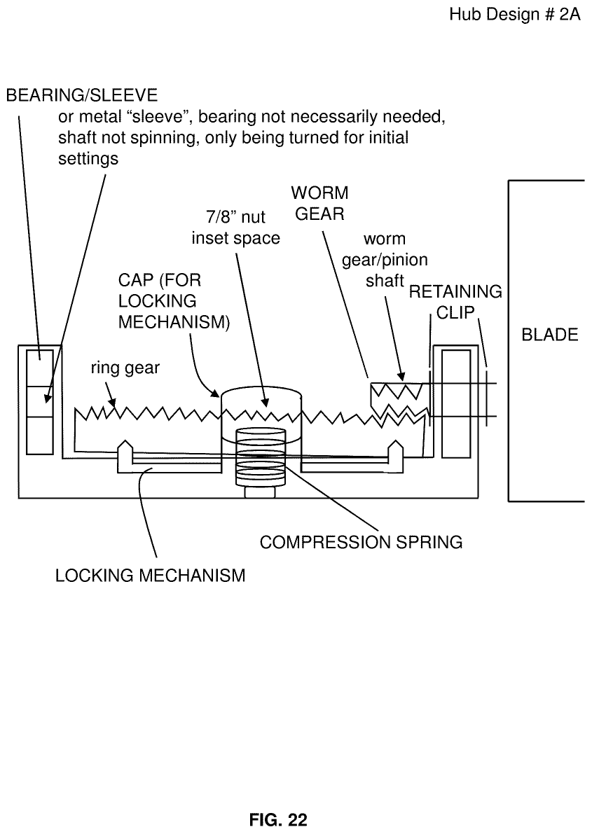

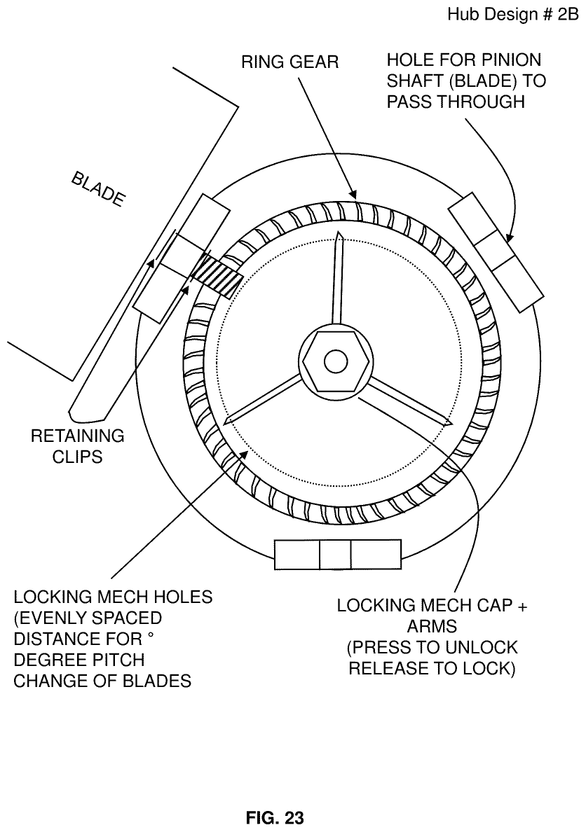

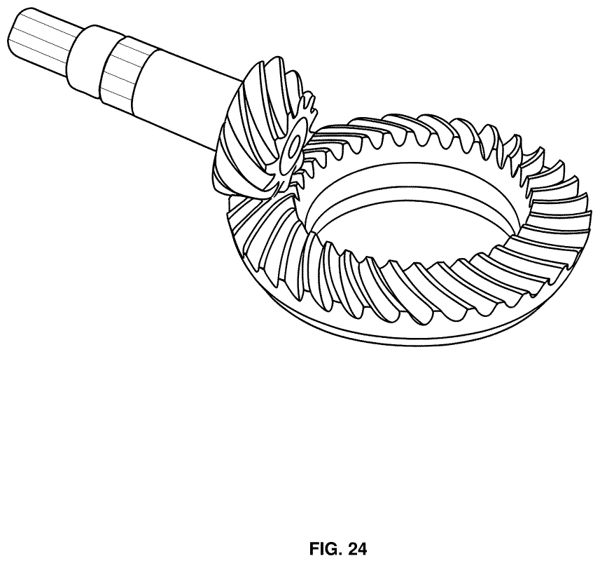

FIG. 22, FIG. 23, and FIG. 24 show an example mechanism for simultaneously adjusting the pitch of blades attached to a blade pitch adjustment device, according to some embodiments. The size(s) and dimension(s) of the hub for the wind turbine can be as described in the foregoing embodiments. In some embodiments, the top of the hub is depressed and this pushes the “locking mechanism” down, releasing the worm gear hub to turn. Releasing the top of the hub allows the locking mechanism to raise (via a biasing element such as a compression spring(s)) to lock the worm gear hub in position.

The example mechanism includes a ring and pinion style mechanism for adjusting the blade pitch. Each blade has a pinion shaft (instead of a threaded rod) as part of the blade device that is inserted into the hub (e.g., through a bearing or sleeve and support) and held in by retaining clips. Other retaining mechanisms can be used.

The hub includes a ring gear attached to it and, when the pinion shaft of a blade is inserted through the bearing/shaft support, the pinion shaft aligns with the ring gear and the teeth of the ring gear and the pinion shaft is configured to keep the blade from rotating freely.

The hub includes a bearing or steel shaft within the hub support section for the blade pinion shaft to pass through (so that when the ring gear is turned, the blade pinion shaft rotates the blade to the desired pitch). The hub support section can also be referred to as the hub base.

In the hub, there is a locking mechanism that, when engaged, will hold the ring gear from turning or moving, thus locking the blade pinion shaft (and blade) in its desired pitch angle.

In order to adjust the blade pitch angle, the blade locking mechanism is actuated, for example, pressed to compress a compression spring or other biasing or compression component, allowing the locking mechanism to unlock from the ring gear and then allowing the depressed cap to be turned by hand (or other mechanism) to rotate the ring gear, thus rotating the pinion shaft of the blades in turn changing the pitch of the blades (to increase or decrease the pitch). To lock the ring gear, thus preventing the pinion shaft to be able to rotate and holding the blade at the desired pitch, the blade locking mechanism is actuated, for example, pressure is removed from the depressed cap and the compression spring will force the cap up thus forcing the locking mechanism up into the ring gear and locking the ring gear from turning and holding the blades in the desired position. The blade locking mechanism includes holes that are evenly spaced apart to allow for incremental pitch angle changes in blades. Arms extending from the centre of the locking mechanism are configured to engage with some of these holes after adjustment and to facilitate locking the ring gear in the desired position. Each blade is secured to the ring gear using an attachment mechanism such as retaining clips. Each blade is attached to the hub at an opening (or set of openings) that allows a pinion shaft of the blade to pass through. Other engagement portions and/or mechanisms can be used for attaching the blade to the hub.

In some embodiments, this mechanism is configured to allow all the pitch angle of each of the blades to be changed at the same time using one location (the centre hub cap). All the blades' pinion shafts can be locked (or unlocked) at the same time. The compression spring (or other biasing or compression component) is configured to hold constant pressure up keeping the locking mechanism engaged unless physically pressed for blade pitch adjustment. An outer cap or cone of the hub can be included to cover and protect this adjustment cap from any potential unwanted unlocking.

In other embodiments, different gear mechanisms, locking mechanisms, or mechanical components may be substituted for those shown. For example, an internal cog toothed wheel can be used instead of an external cogged tooth wheel. As another example, there may be a different mechanism used for unlocking.

FIG. 24 shows an example engagement between a blade device and a hub, according to some embodiments. As shown, a toothed connection of the blade device engages with a toothed connection of the hub, where the blade device is not inserted into the hub, but instead abuts the hub at the toothed connection. The complementary toothed connection between the blade device and the hub can facilitate incremental pitch adjustment of the blade. Additional blades can be engaged with the hub in this way. In various other embodiments, different arrangements and connections can be used that enable incremental blade pitch adjustments.

In other embodiments, other mechanisms can be used for simultaneously adjusting the pitch of each blade connected to a hub.

The embodiments described can be modified. Various other embodiments will now be described.

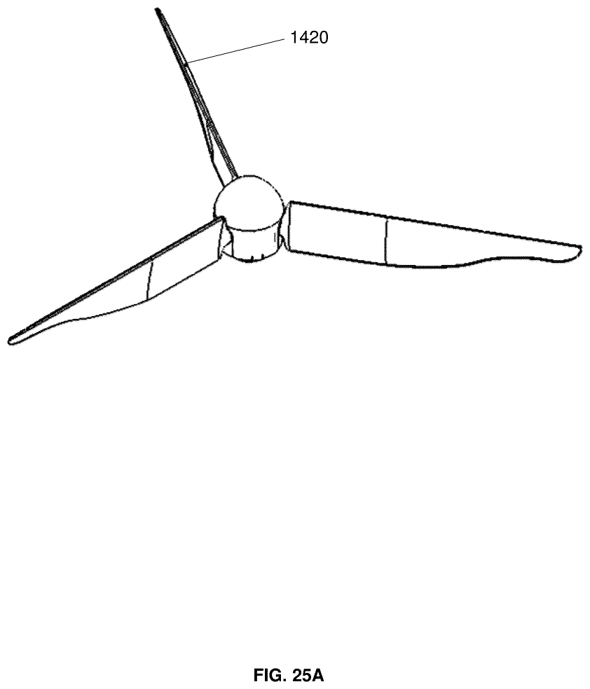

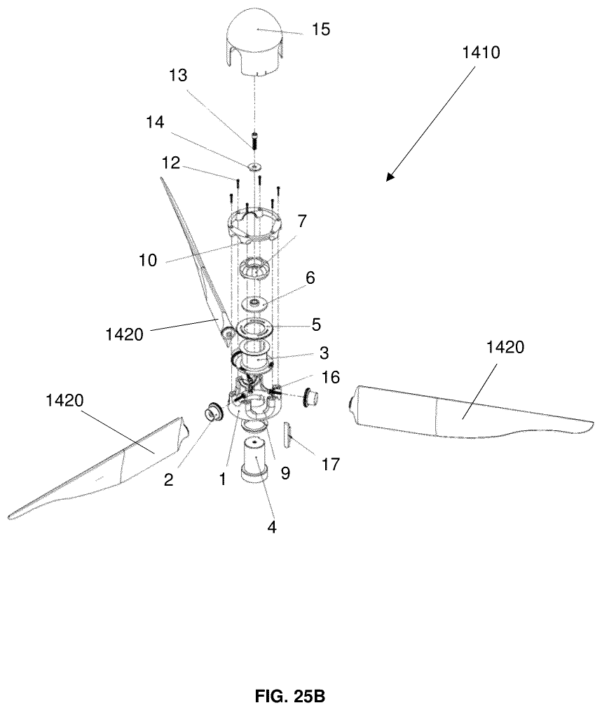

FIG. 25A shows three blades 1420 attached to a blade pitch adjustment device 1410, according to some embodiments. FIG. 25B show an exploded view of an example blade pitch adjustment device 1410, according to some embodiments. Hub 1 is modified to increase its strengthen to hold blades 1420 (or blade devices) to the hub 1 by including a hub base bearing cap 10 that bolts down to hub 1 and creates an opening at each blade 1420 location. The blade opening part where the blade 1420 is clamped in between hub 1 and the hub base bearing cap 10 is like a cam shaft for the blade 1420 (or wing) to set in thus securing it to hub 1. Hub 1 is configured to receive a shaft therethrough. Hub 1 can include an opening or channel to receive the shaft. The opening or channel can be along an axis that is perpendicular or substantially (about +/−10%) perpendicular to the axis defined by an angle of connection between hub 1 and blade 1420, for example. Shaft 4, such as a low torque permanent magnet generator (PMG) shaft, is configured for insertion (e.g., by sliding) into hub 1. A shaft spacer ring 9 can be included at a bottom opening of hub 1 through which shaft 4 is received. Shaft 4 is held from spinning such as via a securing mechanism, for example, a keyway stepped key (shown as 17 in FIG. 25B) and fastener 13 at the end of shaft 4. Fastener 13 can be positioned near or at an axis defined along an axis defined by the insertion of shaft 4 through hub 1. Fastener 13 can be a bolt or M12×30 socket head cap screw, for example. A washer 14 can be included and positioned below fastener 13 and configured to receive fastener 13. Fastener 13 is configured to secure shaft 4. Shaft cap 6 can be included and secured at a top end of shaft 4 by fastener 6. Additional fasteners 12 can also be included along a perimeter of hub bearing cap 10 and can secure hub bearing cap 10 to hub 1. Fasteners 12 can be M5×30 socket head cap screws, for example.

In some embodiments, a blade locking mechanism includes a lock plate 3 at the base end (bottom end) of a hub bearing cap 10, which when depressed by an adjusting device 7, presses or otherwise moves the lock plate 3 out of the way (e.g., in a downward direction) (thus no longer being in a locking state). For example, lock plate 3 is moved to expose bevel pinion gear(s) 2, which can then be engaged with upper ring gear 5. Lock plate 3 can include spaced tooth portions along a perimeter, where such spaced tooth portions engage with bevel pinion gear(s) 2 when in a locking state. In some embodiments, lock plate 3 is slidable. When adjusting device 7 is depressed or otherwise actuated, it engages an upper ring gear 5 which then engages (e.g., pressed onto) bevel pinion gear(s) 2 which are each connected (e.g., bolted or otherwise fastened) to one of blades 1420. Fasteners 16 can be included and used to help secure bevel pinion gear(s) 2 and/or blades 1420 at hub 1. As adjusting device 7 is moved (e.g., rotated or turned) (while still being depressed), adjusting device 7 turns a ring gear 5, which engages and turns bevel pinion 2 on blade 1420 which rotates blade 1420. All blades 1420 (e.g., all three) rotate at the same degree of turn (for example, the gear teeth can be at five degree increments) when adjusting device 7 is actuated (e.g., pressed and turned). Once the desired angle or degree of the blade 1420 (or wing) is achieved by turning adjusting device 7, then adjusting device 7 can be released which returns adjusting device 7 to a locked state. The locked state is secured by a securing or biasing mechanism, for example, compression springs 11 (e.g., three) under sliding locking plate 3. Compression springs 11 are compressed when adjusting device 7 is actuated (e.g., depressed and not in a locked state).

In some embodiments, when adjusting device 7 is depressed or otherwise actuated, adjusting device 7 pushes lock plate 3 downwards and out of the way from gear teeth of blade(s) 1420. This allows adjusting device 7 to be rotated thus rotating the blade pitch of blade(s) 1420. Once adjusting device 7 is released (from being pressed) sliding locking plate 3 re-engages with the blade 1420 gear teeth (e.g., bevel pinion 2). This locks blades 1420 into place and impedes rotation. Blades 1420 can only be rotated (for pitch adjustment) by pressing adjusting device 7 and rotating it while its pressed, according to some embodiments. In some embodiments, nose Cap 15 is removed in order to gain access to adjusting device 7 to make blade pitch adjustments. Nose cap 15 is configured to protect the hub 1 assembly, according to embodiments.

In some embodiments, in operation, when actuated (e.g., pushed downwards), projection(s) from a bottom surface of adjusting device 7 move through corresponding slots in ring gear 5 (or other equivalent toothed device) and contacts and moves lock plate 3 (e.g., pushes lock plate 3 downwards) such that the portion of lock plate 3 (e.g., teeth or gear portions or other portions) that engage bevel pinion 2 (or toothed portion of blade device 1420) are moved away from interlocking with the bevel pinion 2 of the blade device 1420. When adjusting device 7 is further actuated (e.g., rotated or turned), ring gear 5 is correspondingly actuated (e.g., the projections of adjusting device 7 that are moved through and retained by corresponding slots of ring gear 5 cause ring gear 5 to turn when adjusting device 7 is turned), and the turning or rotation of ring gear 5 correspondingly turns or rotates the pitch of blades 1420. In some embodiments, this is through ring gear's 5 toothed engagement with corresponding teeth of bevel pinion 2. Biasing elements, such as springs, are wedged or retained in a tight fit between the base of hub 1 and the base of locking plate 3. The bottom surface of locking plate 3 can include grooves or other elements to retain or receive the biasing elements. On release of adjusting device 7, such biasing elements push locking plate 3 back in the reverse direction (e.g., upwards), and the teeth or gear portion of locking plate 3 is re-engaged or interlocked with bevel pinion 2. In some embodiments, locking plate 3 cannot rotate freely as it is locked with keyway 17 on shaft 4. In some embodiments, a cap or cone 15 is included as an outer piece fastened or removably secured above adjusting device 7 that can help protect adjusting device 7.

Example dimensions are shown in the figures. Other dimensions can be used in other embodiments.

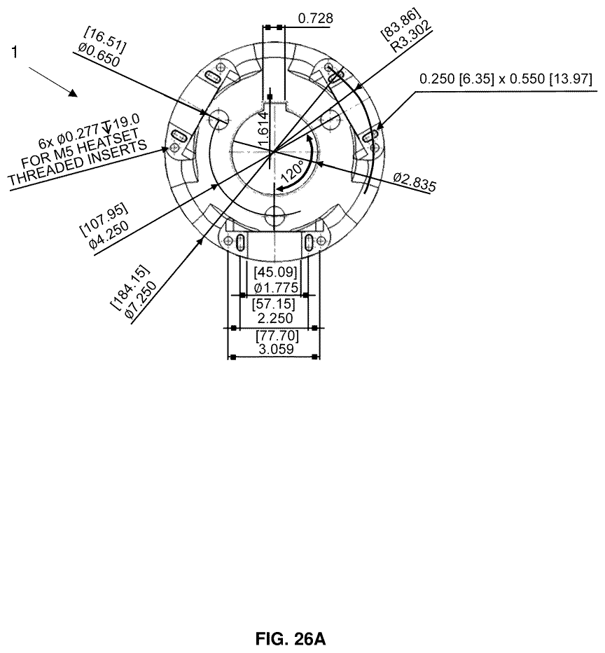

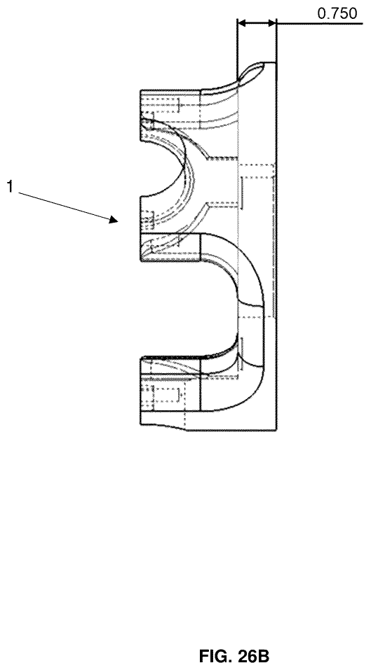

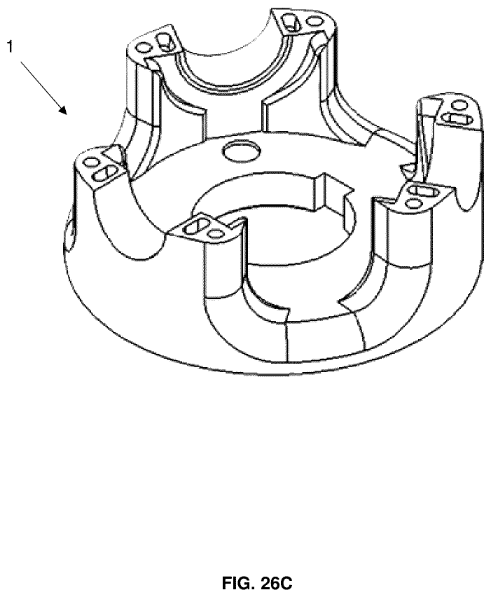

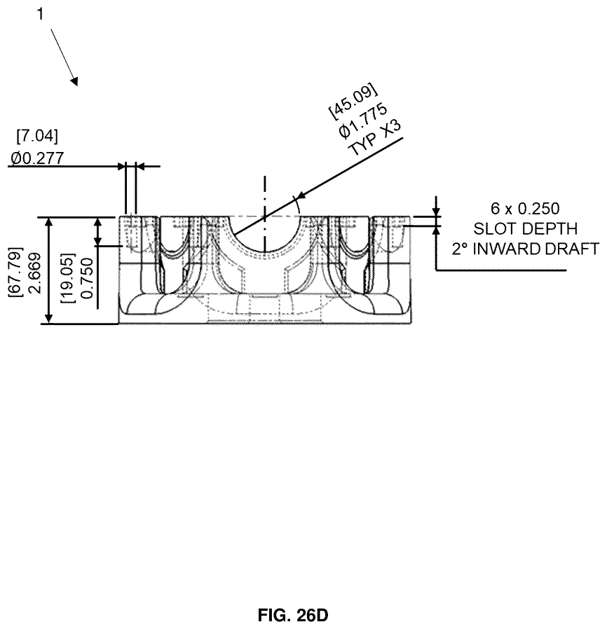

FIG. 26A shows a top view of a hub 1, according to some embodiments. FIG. 26B shows a side view of a hub 1, according to some embodiments. FIG. 26C shows a top perspective view of a hub 1, according to some embodiments. FIG. 26D shows a side view of a hub 1, according to some embodiments. Hub 1 includes an opening in a bottom surface configured to receive a shaft 4, according to some embodiments. Hub 1 includes one or more, such as three, openings spaced apart in a side surface, each opening configured to receive a blade 1420, according to some embodiments. Hub 1 is configured to engage with hub bearing cap 10 in a tight fit when fasteners 12 are applied. Fasteners 12 can be received in complementary openings along a top portion of hub 1, such as at each of six upper surfaces of hub 1. Hub 1 can also include other openings in its side wall to reduce weight and/or material used.

In some embodiments, hub 1 includes grooves or openings in its bottom surface configured to retain or secure biasing devices (e.g., springs) that supports sliding locking plate 3 such that when the adjusting device 7 is actuated (e.g., depressed or moved downwards), the biasing devices are compressed and the sliding locking plate 3 moves away from the blade 1420 (gears) (e.g., bevel pinion 2 or hub connection portion 340) to allow the blades 1420 to be rotated. Once adjusting device 7 is no longer actuated (e.g., is released or not pressed), the biasing devices (that are compressed) push the locking plate 3 back up into the locking state (up against the blade 1420 gear teeth) locking blades 1420 from turning or rotating. The blade 1420 gear teeth can be bevel pinion 2 formed as an integral portion of blade 1420, according to some embodiments. In some embodiments, blade 1420 gear teeth can be bevel pinion 2 that is attached or connected to blade device 1420 as shown in FIG. 25B.

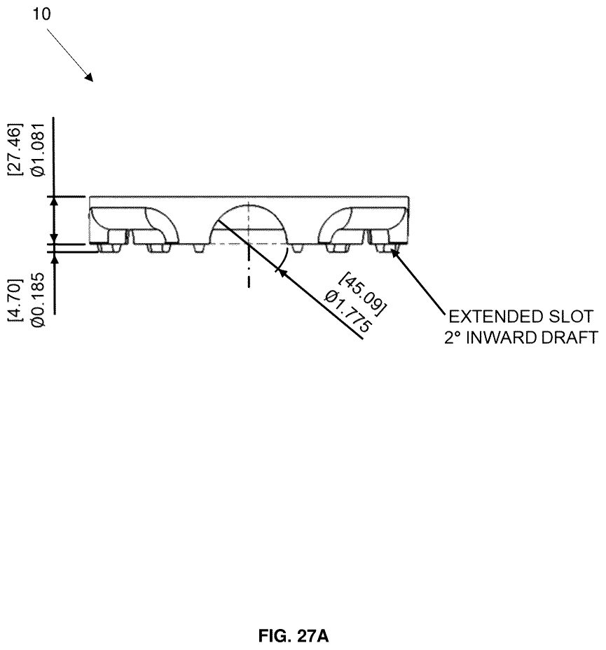

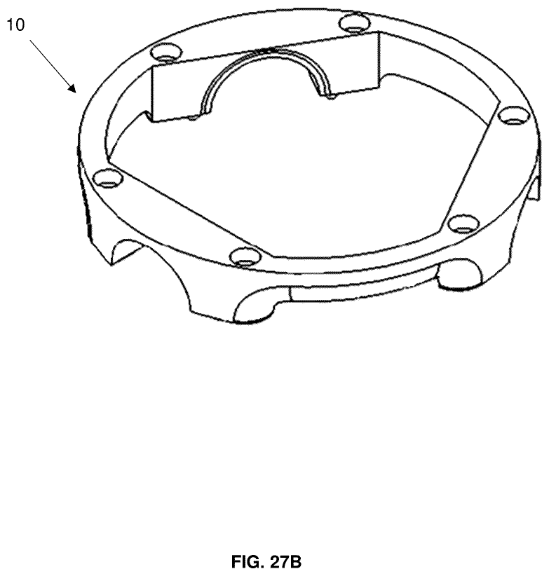

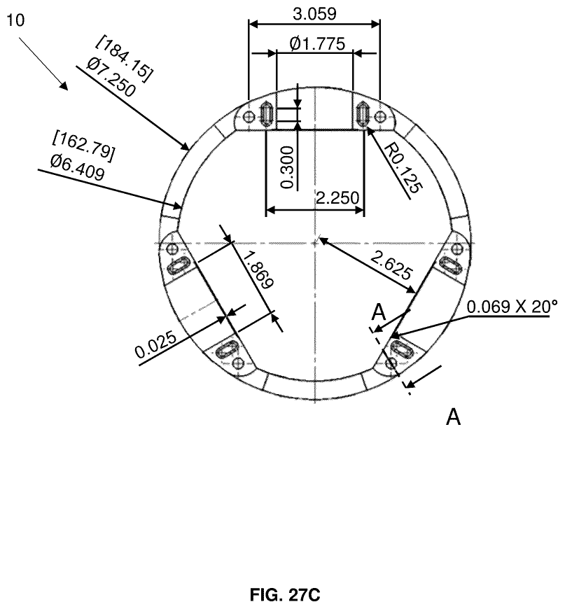

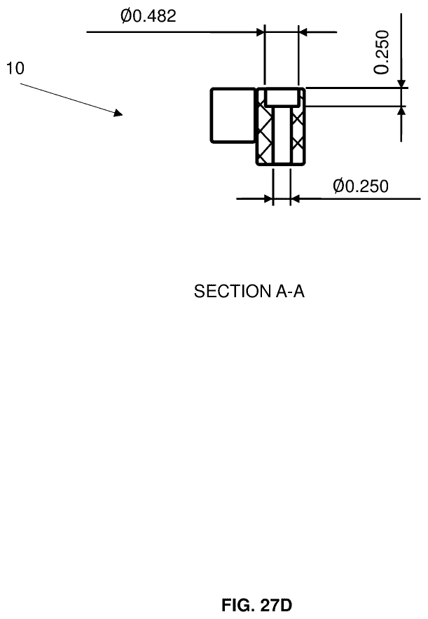

FIG. 27A shows a side view of an example hub bearing cap 10, according to some embodiments. FIG. 27B shows a top perspective view of an example hub bearing cap 10, according to some embodiments. FIG. 27C shows a bottom view of an example hub bearing cap 10, according to some embodiments. FIG. 27D shows a sectional view of an example hub bearing cap 10 along the plane denoted by A-A in FIG. 27C, according to some embodiments. Hub bearing cap 10 is configured to receive fasteners 12, such as near a perimeter of hub bearing cap 10. Hub bearing cap 10 is configured to engage with hub 1 above a top portion of hub 1 in a tight fit when fasteners 12 are applied, in some embodiments. References to hub bearing cap 10 herein are understood to be references to a securing device engageable with hub 1 in various other embodiments. References to hub bearing cap 10 herein are understood to be references to a device engageable with hub 1 and configured to secure or hold at least one component in or at hub 1, for example, to hold at least one blade device 1420 in or at hub 1 by providing a surface opposing a surface of hub 1 with the at least one blade device 1420 (or a connected device) abutting each surface therebetween, in various other embodiments. The securing device can retain or secure other components at hub 1 such as bevel pinion 2, lock plate 3, ring gear 5, shaft cap 6, adjusting device 7, or equivalent devices thereof, in various embodiments.

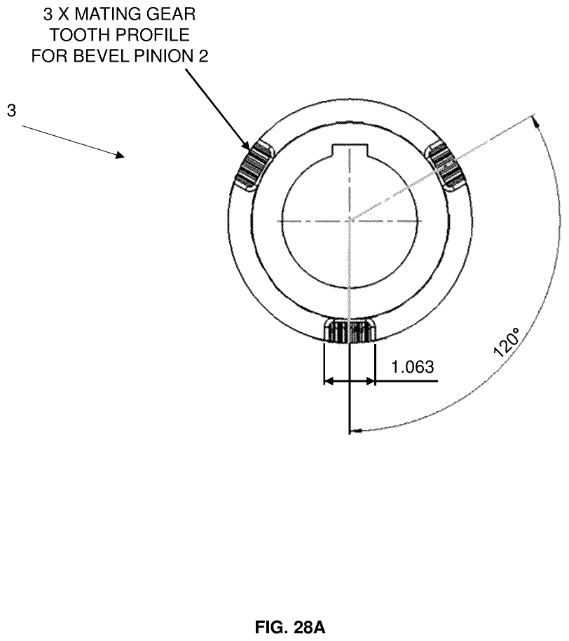

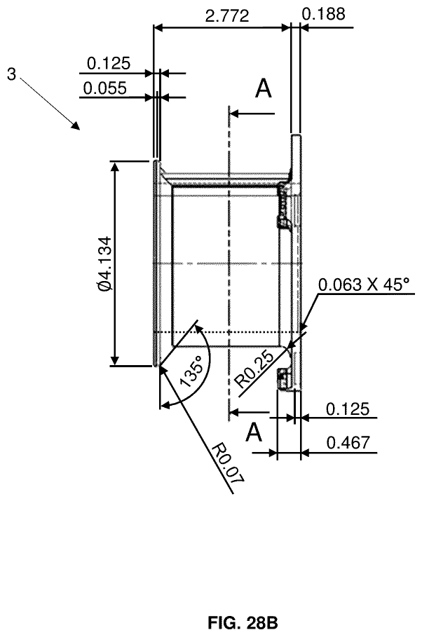

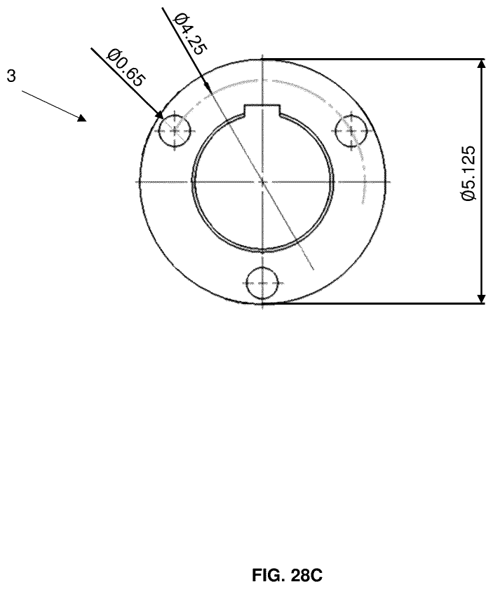

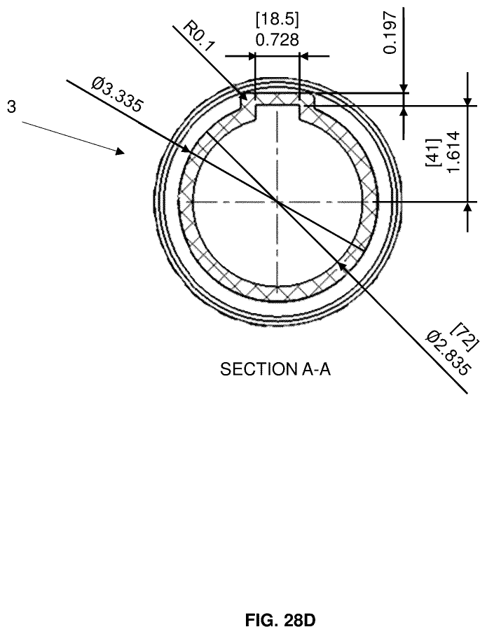

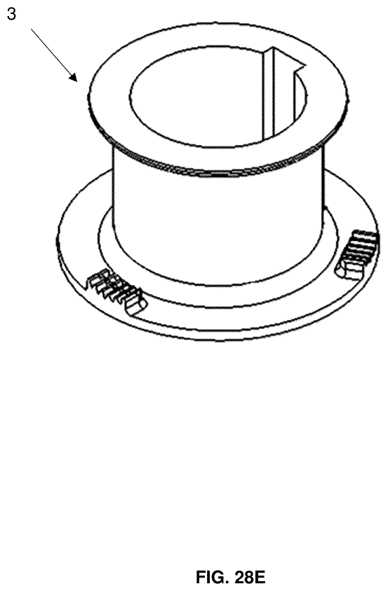

FIG. 28A shows a bottom view of an example lock plate 3, according to some embodiments. Lock plate 3 includes mating gear teeth spaced along a perimeter of a lower surface of lock plate 3. Lower surface can be a lip around an elongated member defining a channel configured to receive shaft 4, for example. The mating gear teeth are configured to engage with bevel pinion 2 in a locking state. FIG. 28B shows a side view of an example lock plate 3, according to some embodiments. FIG. 28C shows a bottom view of an example lock plate 3, according to some embodiments. FIG. 28D shows a sectional view of an example lock plate 3 along the plane defined by A-A in FIG. 28B, according to some embodiments. FIG. 28E shows a perspective view of an example lock plate 3, according to some embodiments. References to lock plate 3 herein are understood to be references to a device engageable with bevel pinion 2 (or equivalent device) in a manner that impedes movement or actuation of bevel pinion 2 (or equivalent device) in various other embodiments. Actuation of bevel pinion 2 refers to bevel pinion 2 causing an adjustment to the pitch of at least one blade device 1420.

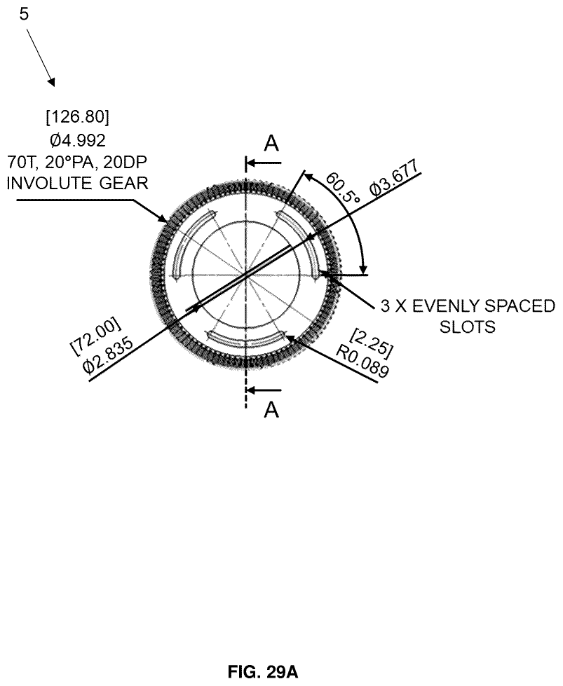

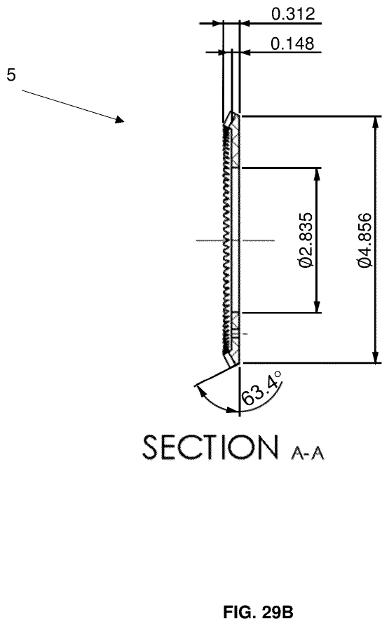

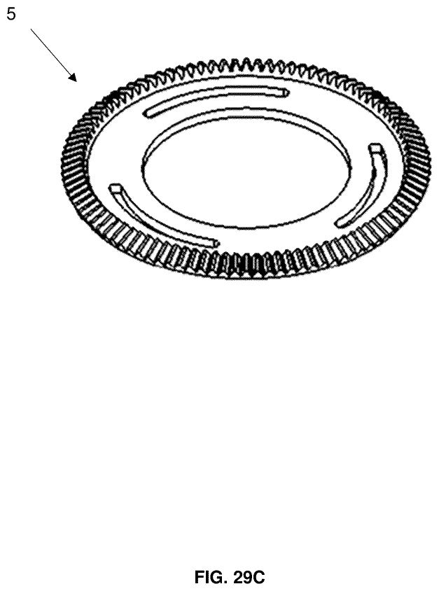

FIG. 29A shows top view of an example ring gear 5, according to some embodiments. In the embodiment shown, ring gear 5 is a ring having a toothed outer perimeter defining an involute gear, for example. Ring gear 5 includes spaced slots, which can be evenly spaced inside the perimeter of the ring gear 5. FIG. 29B shows a side view of an example ring gear 5. The teeth can be present only on a first or top side of ring gear S. FIG. 29C shows a top perspective view of an example ring gear 5. References to ring gear 5 herein are understood to be references to a movable or rotatable device or a gear (e.g., a first gear) engageable with at least one bevel pinion 2 (or equivalent device) in various other embodiments. Movement or rotation of ring gear 5 causes movement or rotation of at least one bevel pinion 2 (or equivalent device), which causes an adjustment in the pitch of blade device(s) 1420.

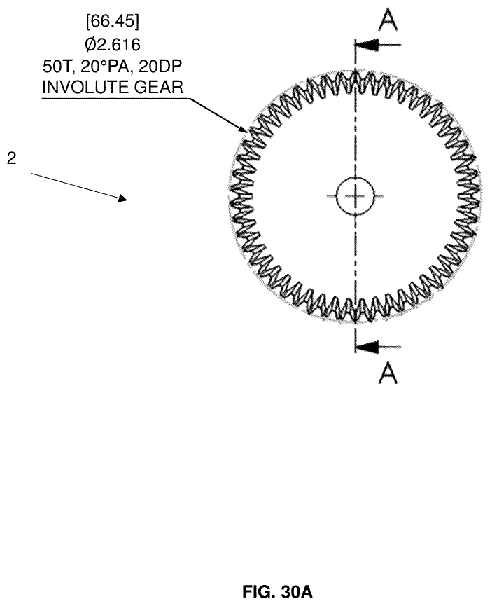

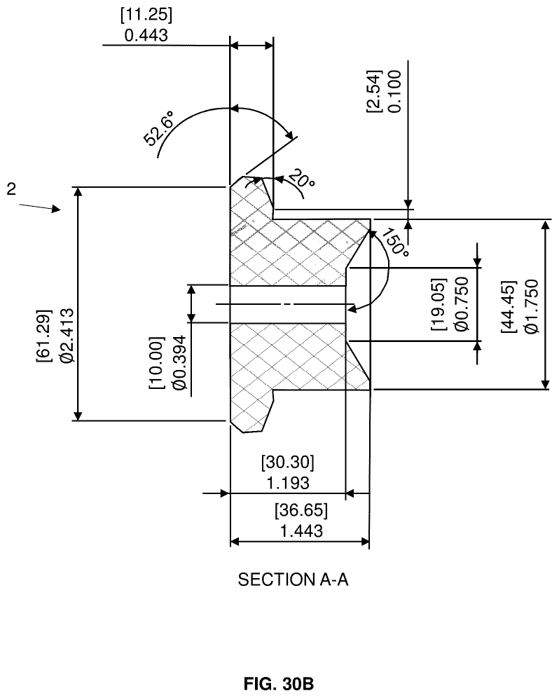

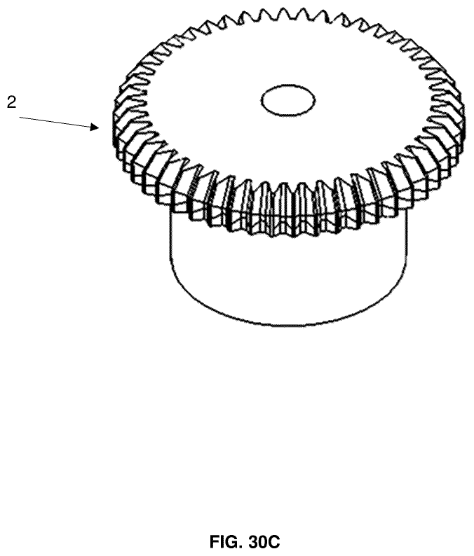

FIG. 30A shows a top view of an example bevel pinion 2, according to some embodiments. Bevel pinion 2 includes a toothed perimeter or gear defining an involute gear, according to some embodiments. The toothed perimeter is configured to engage with a complementary portion of lock plate 3 when in a locking state or upper ring gear 5 when not in a locking state. FIG. 30B shows a sectional view of bevel pinion 2 along the plane defined by A-A in FIG. 30B, according to some embodiments. FIG. 30C shows a top sectional view of an example bevel pinion 2, according to some embodiments. In the embodiment shown, bevel pinion 2 includes a top surface having the toothed perimeter and an elongated member attached to a bottom portion of the top surface, the elongated member defining a channel configured to fastener, such as fastener 16. References to bevel pinion 2 herein are understood to be references to a gear (e.g., a second gear) in various other embodiments. References to bevel pinion 2 herein are understood to be references to a movable or rotatable device engageable with at least one blade device 1420 in various other embodiments. Movement or rotation of bevel pinion 2 causes an adjustment in the pitch of blade device 1420, according to some embodiments. In some embodiments, bevel pinion 2 is an integral (or separate) component of hub 1 and includes blade connection portion 320 an example of which portion is shown in FIG. 3. In some other embodiments, bevel pinion 2 is an integral (or separate) component of blade device 1420 and includes hub connection portion 340 an example of which portion is shown in FIG. 3. In some variant embodiments, such hub connection portion 340 can be a toothed connection capable of engaging with a complementary toothed connection, such as a ring gear 5, that forms blade connection portion 320 of hub 310. In some variant embodiments, ring gear 5 (or equivalent device) is rotatably engaged with one or more second gears (e.g., bevel pinion 2) each rotatably engaged with a separate hub connection portion (e.g., 340) of a separate blade device 1420 (or 330).

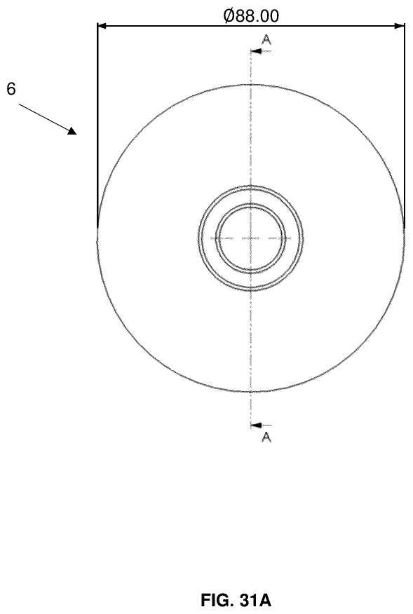

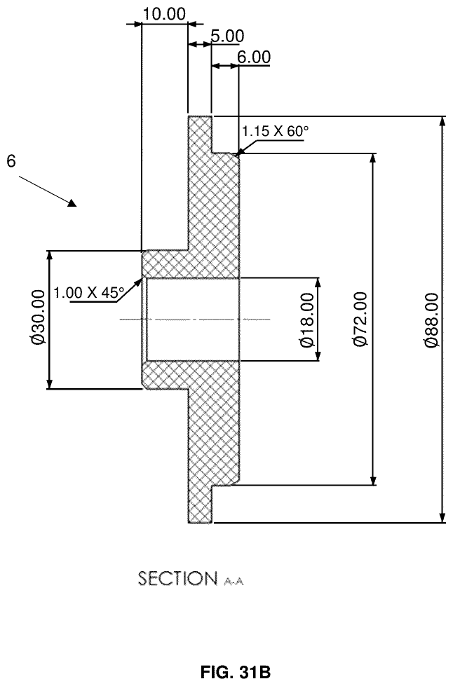

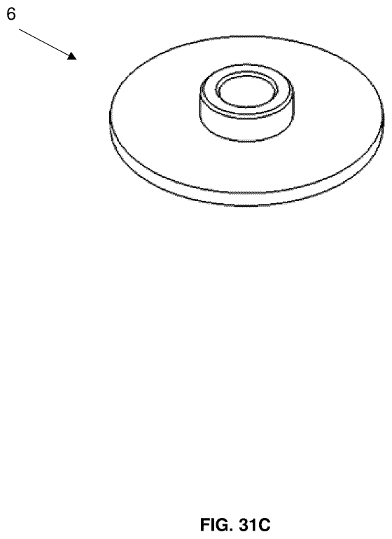

FIG. 31A shows a top view of an example shaft cap 6, according to some embodiments. FIG. 31B shows a sectional view of an example shaft cap 6 along the plane defined by A-A in FIG. 31B, according to some embodiments. FIG. 31C shows a top perspective view of an example shaft cap 6, according to some embodiments. In some embodiments, shaft cap 6 is included. Shaft cap 6 is a spacer that allows cap 15 to be held onto hub 1 when pressed but allows cap 15 to press locking plate 3 to allow blades 1420 to be rotated. Shaft cap 6 allows cap 15 to be bolted to the end of shaft 4 (e.g., PMG shaft 4), and have room to slide when pressed. Shaft cap 6 is a connection piece for cap 15 to shaft 4, according to some embodiments.

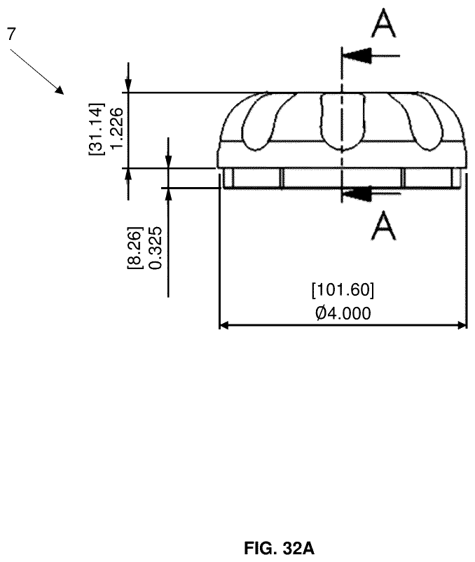

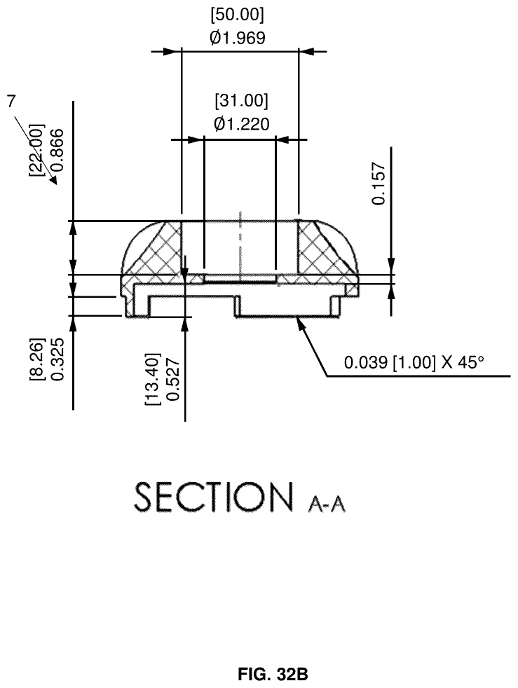

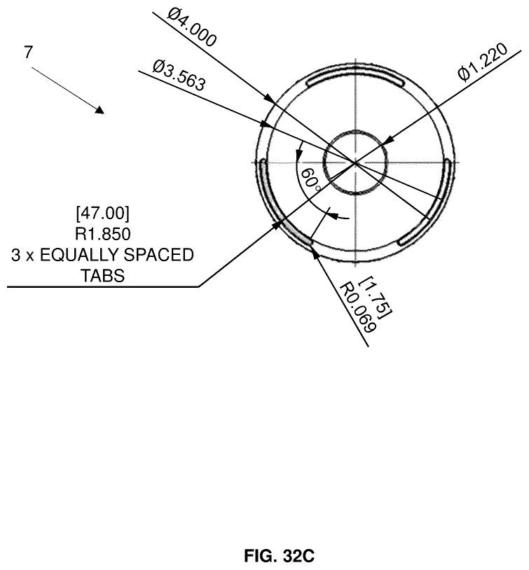

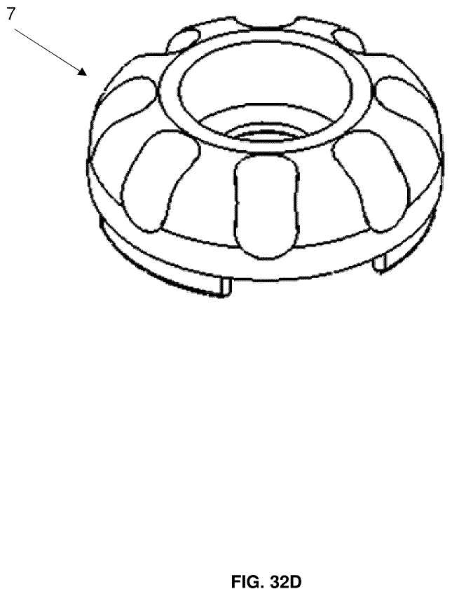

FIG. 32A shows a side view of an example adjusting device 7, according to some embodiments. FIG. 32B shows a sectional view of an example adjusting device 7 along the plane defined by A-A in FIG. 32A, according to some embodiments. FIG. 32C shows a bottom view of an example adjusting device 7, according to some embodiments. FIG. 32D shows a top perspective view of an example adjusting device 7, according to some embodiments. In some embodiments, adjusting device 7 can be a device configured to rotatably engage with ring gear 5 or a device that is usable by a user to machine to actuate rotation of ring gear 5 and/or bevel pinion 2. In some embodiments, adjusting device 7 is an adjusting device.

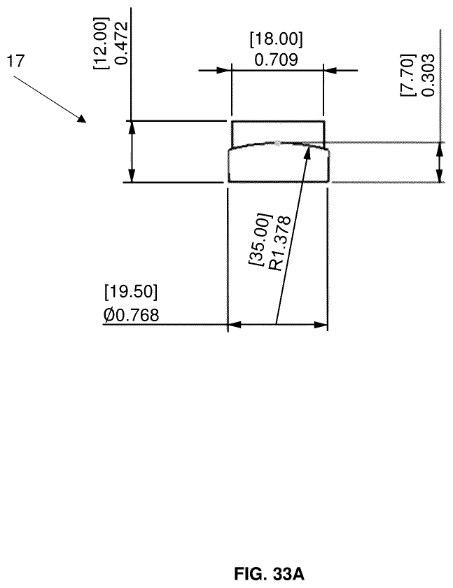

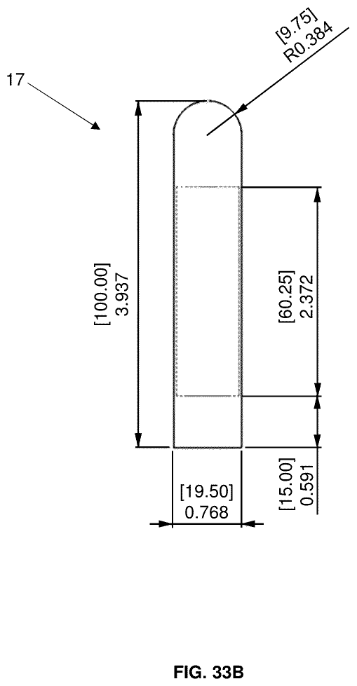

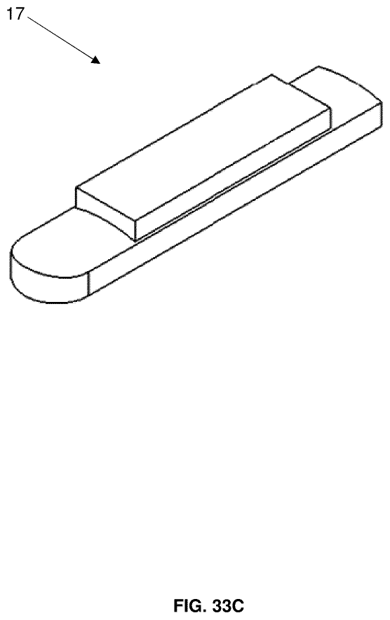

FIG. 33A shows a top view of an example stepped key 17, according to some embodiments. FIG. 33B shows a side view of an example stepped key 17, according to some embodiments. FIG. 33C shows a perspective view of an example stepped key 17, according to some embodiments. In some embodiments, stepped key 17 is included. Stepped 17 fits into a keyway of shaft 4 (e.g., PMG shaft 4) and then into the keyway of the hub 1 assembly so that hub 1 turns or rotates when shaft 4 rotates. A fastener (e.g., bolt) at the end holds the hub 1 assembly onto shaft 4 so it cannot slip off shaft 4.

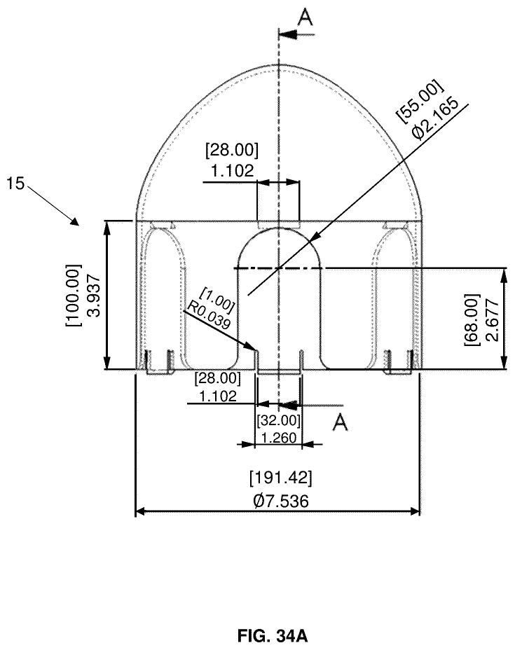

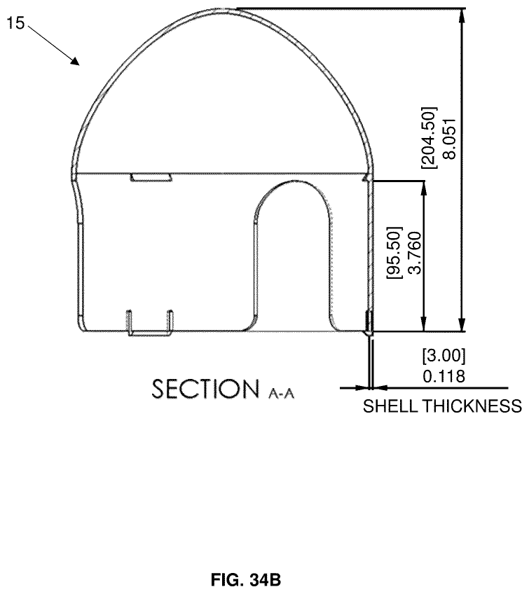

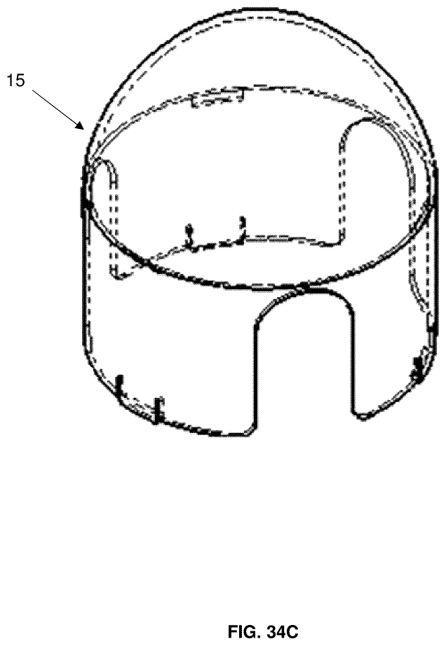

FIG. 34A shows a side view of an example nose cone 15, according to some embodiments. Nose cone 15 can be a cap or other outer covering device in various embodiments. FIG. 34B shows a sectional view of an example nose cone 15 along the plane defined by A-A in FIG. 34A, according to some embodiments. FIG. 34C shows a perspective view of an example nose cone 15, according to some embodiments. Nose cone 15 is sized and dimensioned to fit over adjusting device 7. This can provide a protective outer layer over adjusting device 7 and/or interconnected or adjusting components, including the entire hub 1 assembly in some embodiments. This can provide improved aerodynamics, where wind can blow over nose cone 15. References to nose cone 15 herein are understood to be references to a covering device that is sized and dimensioned to fit over adjusting device 7, according to various other embodiments.

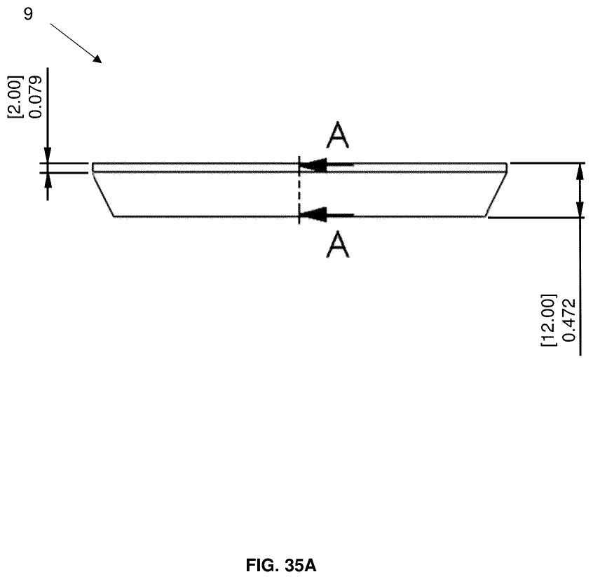

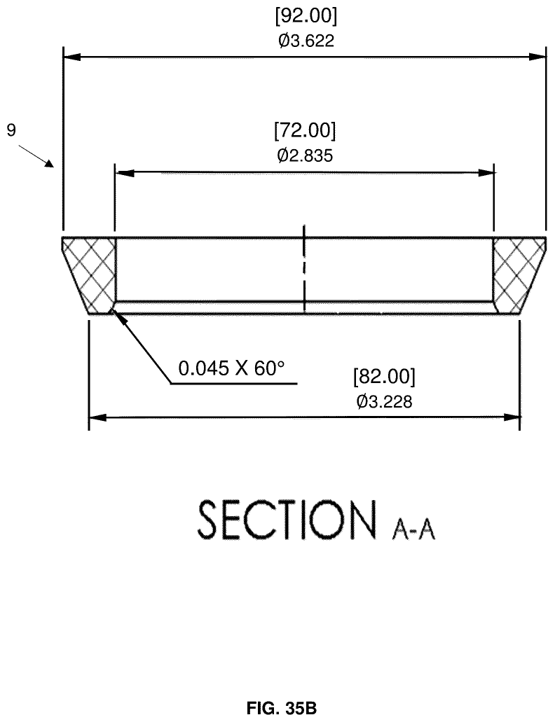

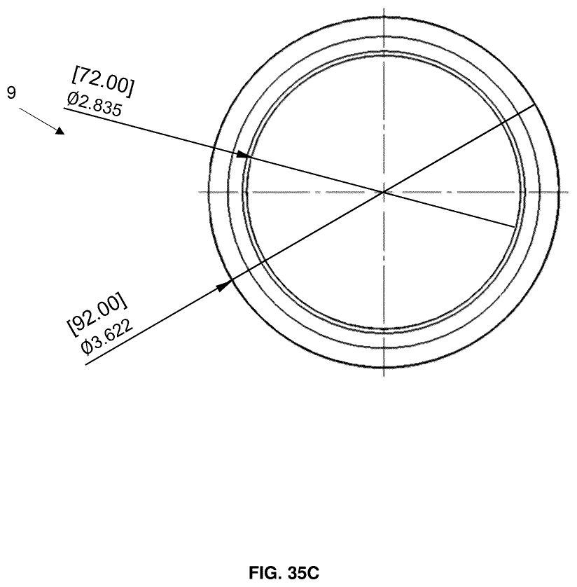

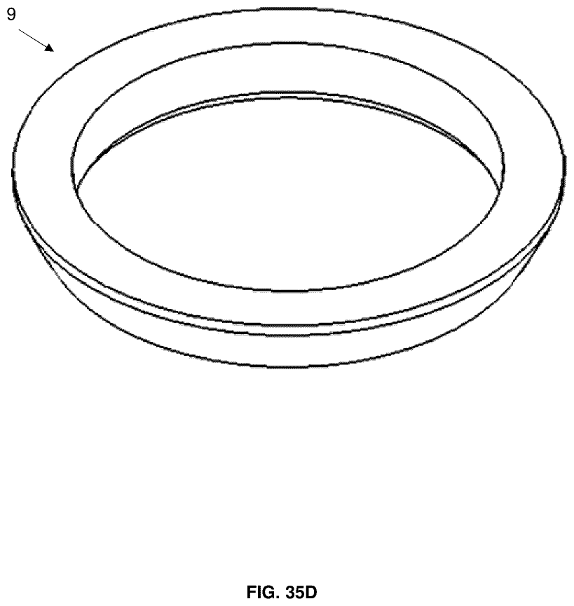

FIG. 35A shows a view of a shaft spacer ring 9, according to some embodiments. FIG. 35B shows a sectional view of a shaft spacer ring 9 along the plane defined by A-A in FIG. 35A, according to some embodiments. FIG. 35C shows a top view of a shaft spacer ring 9, according to some embodiments. FIG. 35D shows a perspective view of a shaft spacer ring 9, according to some embodiments. Shaft spacer ring 9 can include adjoined concentric rings, with the upper ring forming a lip over the perimeter of the lower ring, according to some embodiments. Shaft spacer ring 9 includes an opening or channel through which shaft 4 is received. In some embodiments, shaft spacer ring 9 may not be a ring. Shaft spacer ring 9 is configured to hold hub 1 off shaft 4 (shoulder) to allow clearance from the PMG frame/housing bolts. This can help prevent the base of hub 1 from sitting too far back on shaft 4 and touching the PMG housing bolts, which may prevent hub 1 from rotating as hub 1 would be pinched to the PMG frame/housing. In some embodiments, shaft spacer ring 9 is placed onto shaft 4 prior to the hub 1 assembly being installed to hold the hub 1 assembly off the PMG housing/frame. Shaft spacer ring 9 can help prevent the hub 1 assembly from “bottoming out” and compressing against the PMG housing/frame bolts. In some embodiments, shaft spacer ring 9 forms a part of the base of hub 1 and be included in hub 1 as a single piece.

In various embodiments, one or more of the components described can be integral to each other, that is, formed as a single piece.

In various embodiments, mechanisms and components other than those described in the foregoing can be used to simultaneously adjust the pitch angle of each blade 1420, for example, by depressing, pushing, pulling, engaging, disengaging, or otherwise actuating a blade locking mechanism component that, in turn, engages each blade 1420 or component connected thereto and moves or adjusts the pitch angle of each blade 1420.

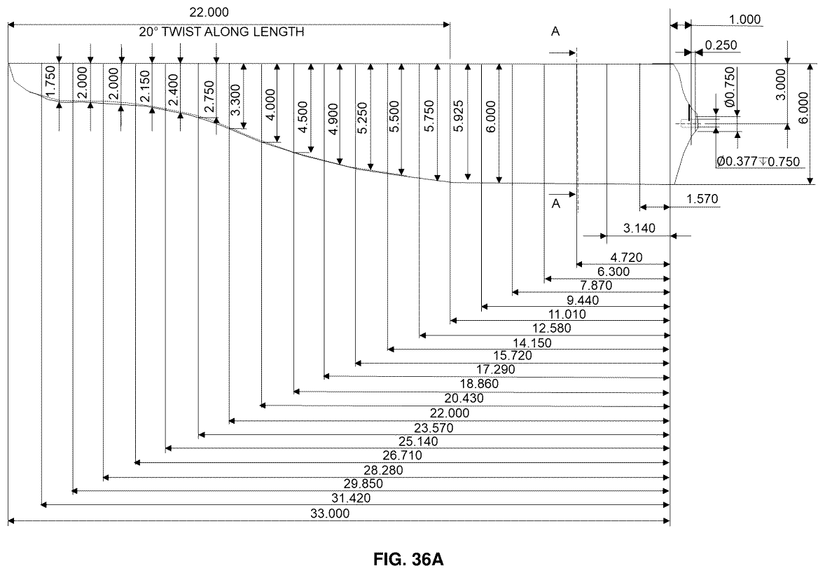

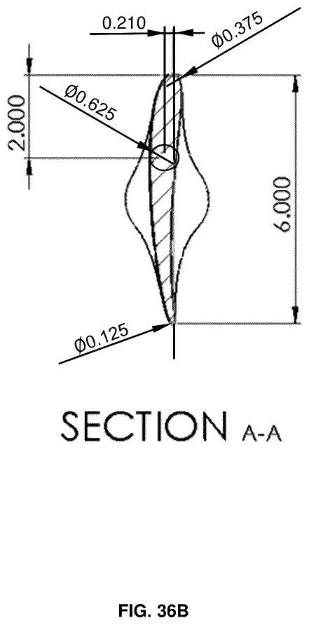

FIG. 36A shows a side view of an example blade 1420, according to some embodiments. The shape and curvature of blade 1420 can be selected based on desired aerodynamic or performance or power-generation parameters. Example dimensions are shown in FIG. 36A. Other dimensions can be selected in other embodiments. FIG. 36B shows a sectional view of an example blade 1420 along a plane defined by A-A in FIG. 36A, according to some embodiments.

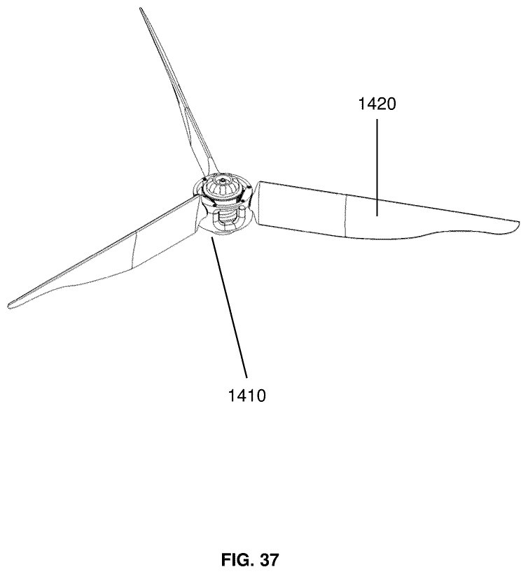

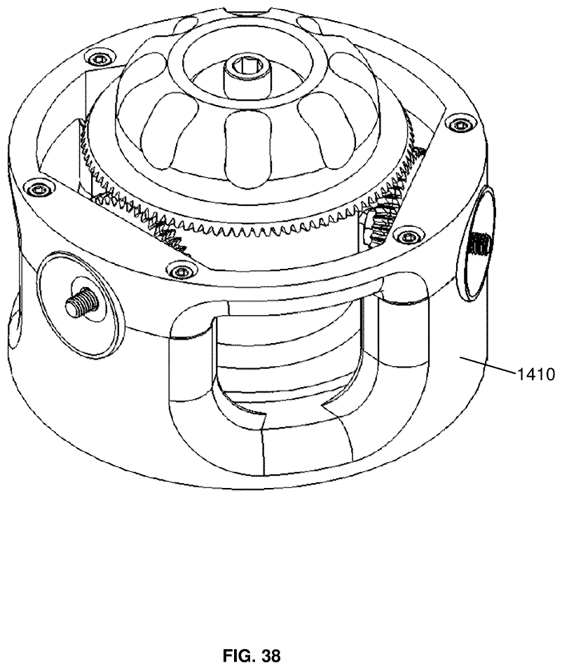

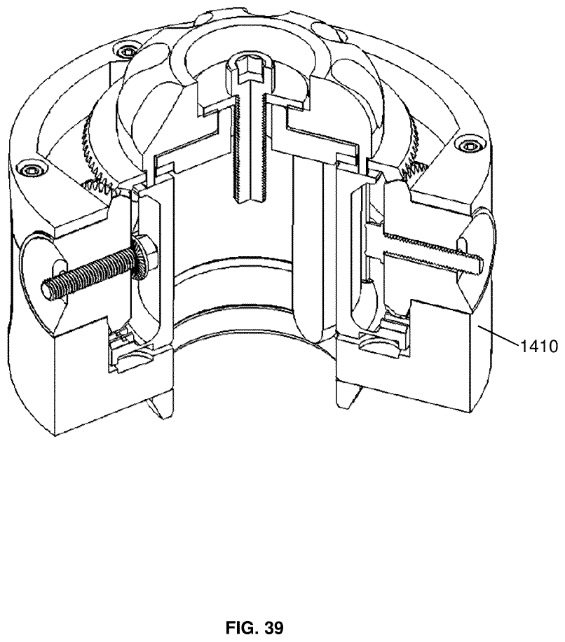

FIGS. 37 and 38 show example blade pitch adjustment device 1410 with example blades 1420 attached, according to some embodiments. FIG. 39 shows a sectional view of an example blade pitch adjustment device 1410 with example blades 1420 attached, according to some embodiments. FIG. 40 shows a perspective view of an example blade pitch adjustment device 1410, according to some embodiments.

In some embodiments, there is provided a method for adjusting a pitch of each blade of a wind turbine, the method including: rotationally connecting each blade to the wind turbine about an axis relative to which blade pitch is measured and rotationally connecting each blade directly or indirectly to at least one gear. Each blade can be a blade device 1420, for example. Each blade can be radially connected to a hub (e.g., hub 1) of the wind turbine, with each blade capable of being rotated to adjust the pitch of the blade. The rotational connection can include, for each blade, a bevel pinion 2 (or other gear or other toothed connection, depending on the embodiment) engaged with the blade at a first end and engaged, directly or indirectly, with the same ring gear 5 (or other gear or other toothed connection, depending on the embodiment), such that rotation of the ring gear S rotates each bevel pinion 2, which in turn rotates the respective blade connected thereto.

In some embodiments, the at least one gear is a same single toothed device, such as the ring gear 5, rotation of which rotates all of the blades (such as via separate bevel pinions 2 connecting the single ring gear 5 to a respective blade) to adjust the pitch of each blade.

In some embodiments, the method includes simultaneously adjusting the pitch of each blade by rotating the at least one gear, such as the ring gear 5.

In some embodiments, the at least one gear is only one first gear (e.g., the ring gear 5) rotatably engaged with two or more subsequent gears (e.g., two or more bevel pinions 2 or other type of gear or toothed connection) each rotatably engaged with one of the blades.

In some embodiments, the method further includes locking the gear to impede rotation of each blade. This can be by including a device such as a lock plate 3 that engages with one of the gears (e.g., the bevel pinions 2) to prevent its rotation.

Unless defined otherwise, all technical and scientific terms used herein have the same meaning as commonly understood by one of ordinary skill in the art to which this disclosure belongs.

As used herein, the term “about” refers to an approximately +/−10% variation from a given value. It is to be understood that such a variation is always included in any given value provided herein, whether or not it is specifically referred to. As used herein, the term “gear” includes a device capable of transmitting rotational motion and/or torque; a device capable of transmitting rotational motion and/or torque by engagement of its teeth with compatible teeth of another gear or other component; as well as a device having a toothed connection configured for engagement with a component. As used herein, an “indirect” connection refers to a connection via or through one or more other components. As used herein, “connectible” refers to separate components capable of being connected; separate components capable of being fixedly attached; as well as a single component comprising both portions described as being “connectible”.

To gain a better understanding of embodiments described herein, the following examples are set forth. It will be understood that these examples are intended to describe illustrative embodiments and are not intended to limit the scope of the present disclosure in any way.

### EXAMPLES

### Example 1

In some embodiments, there is provided a blade pitch adjustment device including a hub assembly and a blade/wing assembly. The hub assembly (that bolts directly to a wind turbine) has degree angle teeth where the blade/wing attaches to allow for the blade/wing to be rotated to adjust pitch. A blade/wing assembly (that attaches to the hub assembly) has degree angle teeth that match the hub assembly connection (to allow the blade to be connected and also to allow for rotation of the blade/wing to adjust the pitch of the blade/wing).

The blade pitch adjustment device can be installed at a calculated distance from commercial rooftop exhaust units to capture exhaust air blown out of units (into the atmosphere) and harness that wind to turn the turbine thus creating energy/power for the buildings consumption and or to return to the grid for cost savings by that building.

The blade/wing assembly is configured such that the pitch can be adjusted to obtain maximum rotation based on the dynamic wind present. The blade pitch adjustment device includes a hub assembly to attach the blade/wing assembly to a wind turbine generator. This advantageously allows a user to adjust the blade pitch on small turbines (e.g., 1 kW to 10 kW turbines). In particular, the blade pitch adjustment device provides a non-fixed blade assembly where adjustment of its pitch is possible.

To capture and turn the wind energy coming from an HVAC system or commercial sized rooftop exhaust unit, the blade pitch the blades of a wind turbine can be adjusted. Embodiments described herein allows for adjustment of the pitch of a blade (e.g., wing) to facilitate maximum air resistance to facilitate maximum blade rotation without putting the generator into an over current state where the blades rotate too quickly.

Harnessing this wind can help put back energy/power back into the building/grid system. In some embodiments, blade pitch adjustment device 110 can be used with any source of manufactured wind energy that can be harnessed.

In some embodiments, blade pitch adjustment device 110 provides advantages such as by not requiring a fixed connection between blades (e.g., wings) to a hub assembly of a wind turbine, which does not allow for pitch adjustment. Where such a connection is permanently fixed, the wind turbine may be used to capture as much air flow as possible from wind generated by nature. Instead, blade pitch adjustment device 110 can be used to capture a “static” flow of air (e.g., generated from an exhaust) and, accordingly, the pitch of blades used in such wind turbines can benefit from being adjustable so as to maximize the turbine rotation without going into overcurrent status (rotating too fast).

Fixed blade assemblies provide no ability to adjust to specific controlled wind speeds, whereas blade pitch adjustment device 110, in some embodiments, allow for the pitch of a blade/wing to be adjusted such as to maximize speed while helping ensure that the blades do not rotate too fast (e.g., putting the turbine generator into “overcurrent” status, which can shut down the unit down or burn it out).

Once the wind energy is captured, the turbine can transform it into power or electricity.

In some embodiments, the pitch adjustments are made by loosening a connecting nut on the blade shaft (that goes through the hub), rotating the blade to the desired pitch, re-tightening the connecting nut (which in turn tightens the blade device to the hub). The blade device is not physically disconnected all the way when performing this adjustment; the connecting nut is loosened just enough to allow the blade teeth and the hub teeth to have enough space to rotate to the desired pitch and then be re-tightened.

In some embodiments, the pitch angle/degree of each blade device is determined by the size of exhaust fan, the cubic feet per minute (CFM) of air movement, wind speed (m/s), and/or volume that is being blown out of the exhaust. Control panel(s) connected to the device can be used to help determine this based on the efficiency of power being created by the turbine and blades. For example, too little blade pitch catches too much air and makes the blades spin too fast putting the unit into overcurrent, while too much blade pitch does not catch enough air and the blades will not spin fast enough putting the unit into an undercurrent state where it may not produce the optimal or maximum current possible. Every building or location at which blade pitch adjustment device 110 is installed can have different sized exhaust fan(s) and so may benefit from tailored adjustment to the pitch of the blade devices installed there, so as to facilitate obtaining an optimal speed without going into overcurrent where the turbine is spinning too fast. Adjusting the blade pitch can facilitate catching less of the air being blown to not go faster than the desired speed. Using data on the typical wind speed (e.g., m/s) from different exhaust fan types and learning the typical wind speed from each sized unit, blade pitch adjustment device 100 can be configured with a close pitch adjustment for an initial start-up with only more minor adjustments after that. Once the optimal or desired pitch is obtained, the blade pitch may not need to be adjusted again, unless there is a change in the air flow (e.g., m/s) from the air source that the wind turbine is installed at, such as where fan breaks down and a new fan with a different wind speed (m/s) is installed at that location. The control panel(s) can facilitate collection of the data used.

### Other Examples

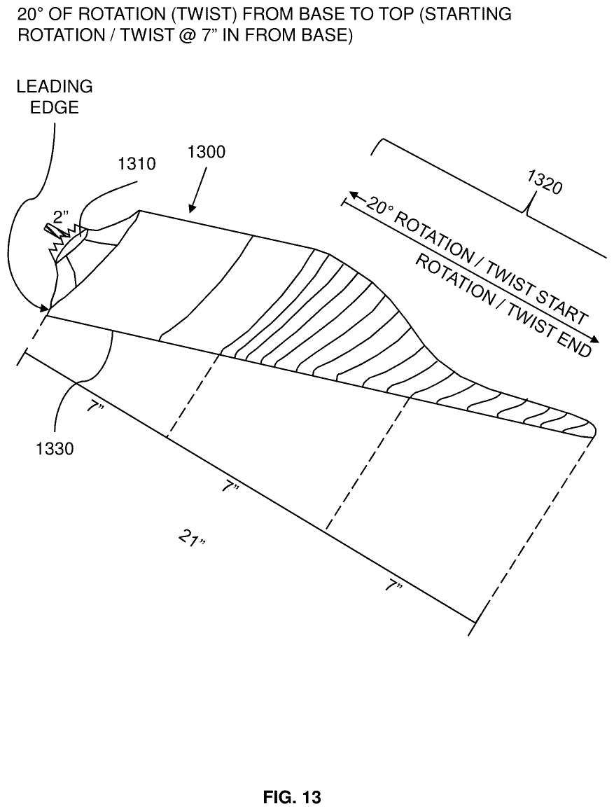

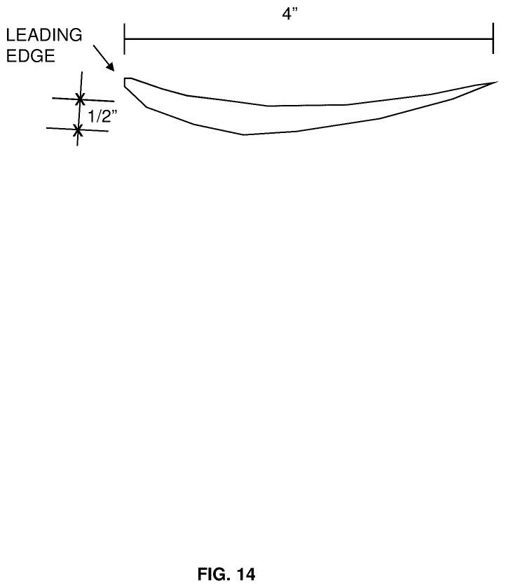

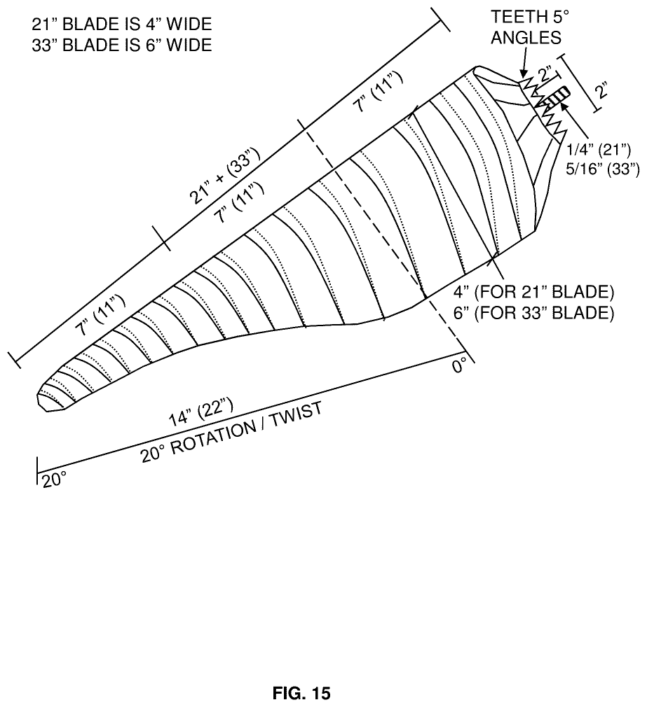

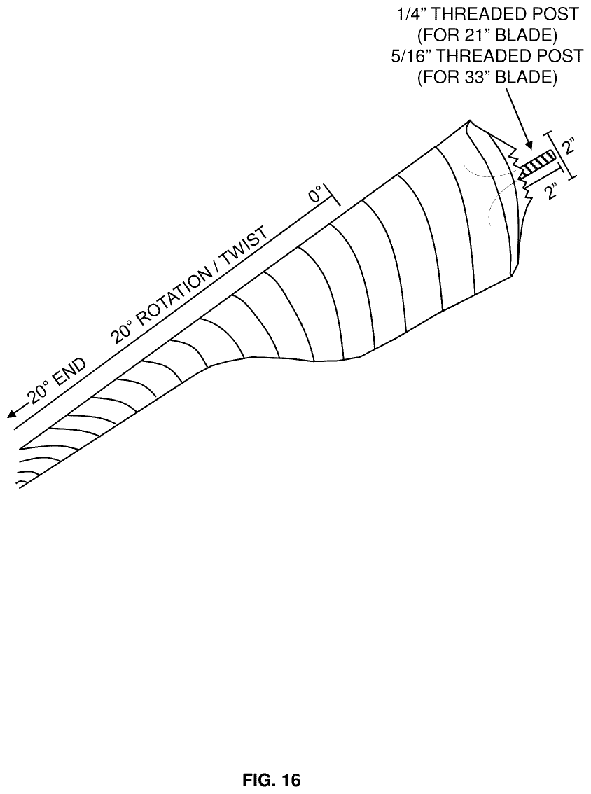

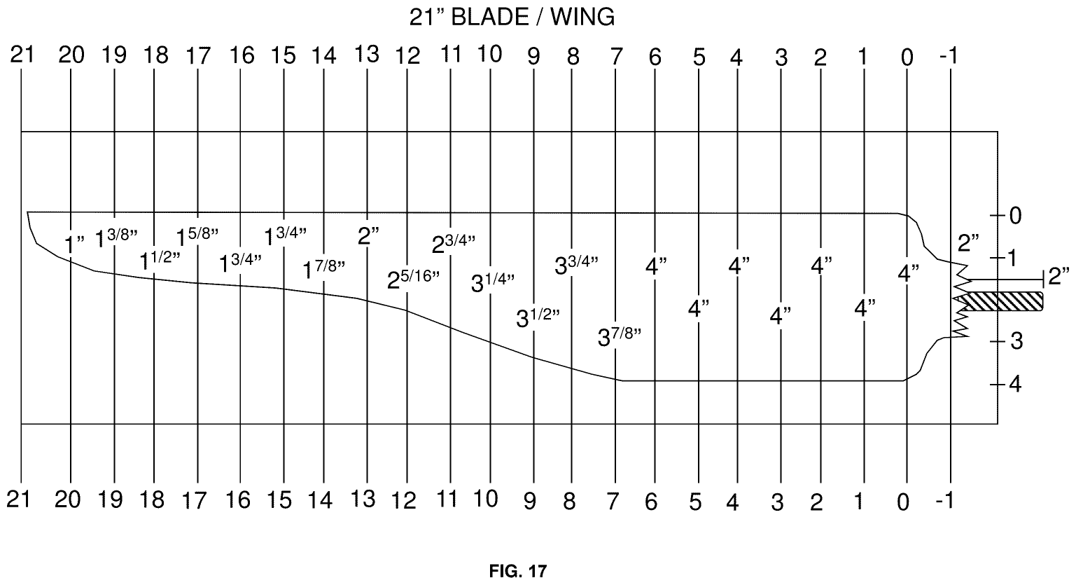

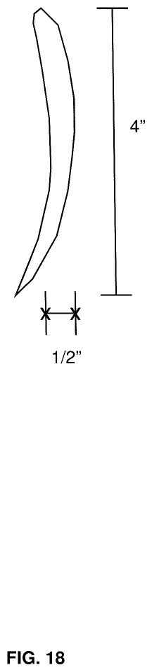

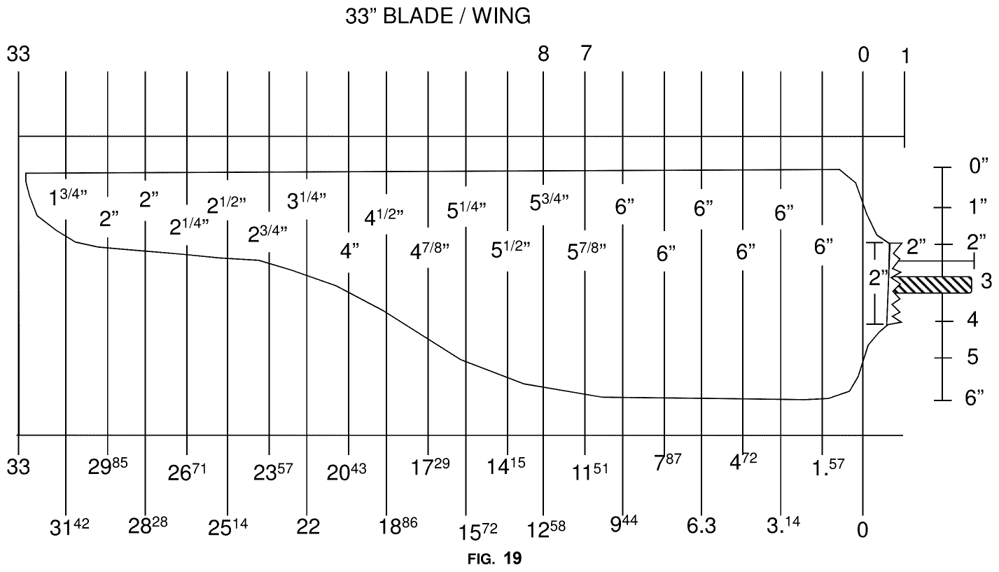

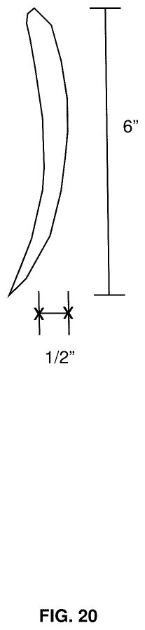

FIGS. 13, 14, 15, 16, 17, 18, 19, and 20 are a side views of various example embodiments of blade devices, in accordance with some embodiments. As shown in FIG. 13, the blade device 1300 including a blade has a portion 1320 of the blade that is rotated or twisted. This portion 1320 is located at the end opposite to the hub connection portion 1310. The degree of twist or rotation of this portion 1320 of the blade is 20°. Other degrees can be used in other embodiments. The degree can be selected based on the desired speed of blade movement desired or amount of wind desired to be caught by the blade, for example. A curved portion of the blade portion of blade device 1300, including the portion 1320 that is rotated or twisted, is opposite a leading edge 1330 of the blade device 1300, according to some embodiments.

Various dimensions and lengths are shown in these drawings. In other embodiments, other dimensions can be used.

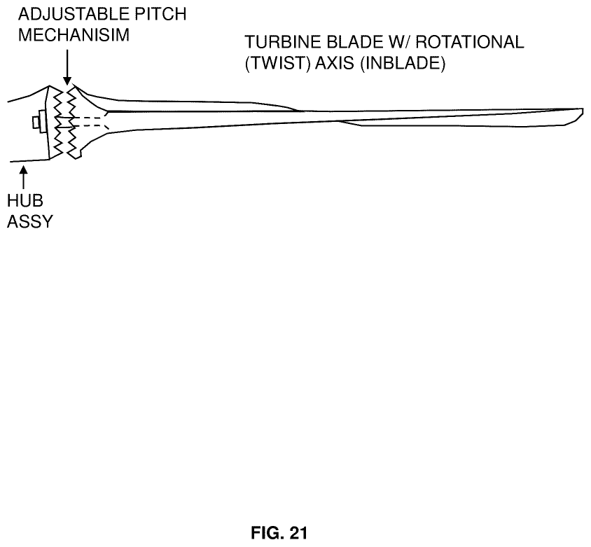

FIG. 21 is a side view of a blade pitch adjustment device, in accordance with some embodiments.

Although the present disclosure has made reference to certain specific embodiments, various modifications thereof will be apparent to those skilled in the art. All such modifications as would be apparent to one skilled in the art are intended to be included within the scope of the following claims.

What is claimed is:

1. A blade pitch adjustment device, comprising:
a hub connectible to a wind turbine, the hub engageable with at least one blade device each at a blade connection portion, each blade connection portion permitting adjustment of the pitch of the blade device.

2. The blade pitch adjustment device of claim 1, wherein each blade device is rotatably engaged with the hub and the adjustment of the pitch of each blade device is by simultaneous rotation of each blade device.

3. The blade pitch adjustment device of claim 1, further comprising a first gear rotatably engageable with at least one second gear, each at least one second gear rotatably engageable with one of the blade devices, wherein the adjustment of the pitch of each blade device is by rotation of the first gear.

4. The blade pitch adjustment device of claim 1, wherein each blade connection portion comprises a toothed connection.

5. The blade pitch adjustment device of claim 4, wherein the hub has angled teeth engageable with angled teeth of each blade device at each blade connection portion.

6. The blade pitch adjustment device of claim 5, wherein at least one of the angled teeth of the hub or the angled teeth of each blade device are present along the entire perimeter of the hub or blade device.

7. The blade pitch adjustment device of claim 1, further comprising a blade shaft at a hub connection portion of each blade device and extending from inside the blade device to outside the blade device, the blade shaft engageable with the hub.

8. The blade pitch adjustment device of claim 7, for each blade device, the blade shaft extending outside the blade device at a rod portion, the rod portion extendible through the hub.

9. The blade pitch adjustment device of claim 1, the hub further comprising a ring gear, the ring gear positioned over a hub base, a perimeter of the hub configured to receive a pinion shaft of at least one of the at least one blade, each pinion shaft rotatable with rotation of the ring gear to adjust a pitch of each blade.

10. The blade pitch adjustment device of claim 9, wherein each pinion shaft is received by the hub at equally spaced intervals along the perimeter of the hub.

11. The blade pitch adjustment device of claim 9, further comprising a locking mechanism compressible and releasable to lock and unlock the ring gear.

12. A method for adjusting a pitch of at least one blade of a wind turbine, the method comprising:
detaching the at least one blade from the wind turbine;
rotating the at least one blade to a specified pitch; and
attaching the at least one blade to the wind turbine at the specified pitch.

13. The method of claim 12, further comprising increasing a number of toothed engagement points between the at least one blade and the wind turbine when the at least one blade is attached to the wind turbine.

14. The method of claim 12, wherein the wind turbine comprises a wind turbine and a hub, the detaching being from the hub, the attaching being to the hub.

15. The method of claim 14, the detaching comprising loosening a connection of a blade shaft extending through the hub, the attaching comprising tightening the connection of the blade shaft extending through the hub.

16. A method for adjusting a pitch of each blade of a wind turbine, the method comprising:
rotationally connecting each blade to the wind turbine about an axis relative to which blade pitch is measured and rotationally connecting each blade directly or indirectly to at least one gear.

17. The method of claim 16, wherein the at least one gear is a same single toothed device.

18. The method of claim 16, further comprising simultaneously adjusting the pitch of each blade by rotating the at least one gear.

19. The method of claim 16, the at least one gear comprising only one first gear rotatably engaged with two or more subsequent gears each rotatably engaged with one of the blades.

20. The method of claim 16, further comprising locking the gear to impede rotation of each blade.
